(19) United States
(12) Patent Application Publication
(10) Pub. No.: US 2026/0228657 A1
(43) Pub. Date: Aug. 6, 2026

(54) TASK SUPPORTING DEVICE, TASK SUPPORTING METHOD, AND TASK SUPPORTING SYSTEM

(71) Applicant: Mitsubishi Electric Corporation, Tokyo (JP)

(72) Inventors: Atsushi KONDO, Tokyo (JP); Atsuki TACHIBANA, Tokyo (JP); Shinichi KATO, Tokyo (JP); Asako AKIYAMA, Tokyo (JP); Yuka HIRAI, Tokyo (JP); So SATOH, Tokyo (JP); Kae OHASHI, Tokyo (JP)

(73) Assignee: Mitsubishi Electric Corporation, Tokyo (JP)

(21) Appl. No.: 19/630,501

(22) Filed: Mar. 27, 2026

Related U.S. Application Data
(63) Continuation of application No. PCT/JP2023/037310, filed on Oct. 16, 2023.

(51) Int. Cl. G06Q 10/0631

(52) U.S. Cl. CPC G06Q 10/063114

(57) ABSTRACT

A task supporting device includes: a task identifying unit that identifies a task to be a support target; and a text information acquiring unit that acquires text information about a task sound that is a sound indicating the task identified by the task identifying unit.

### CROSS-REFERENCE TO RELATED APPLICATION

This application is a Continuation of PCT International Application No. PCT/JP2023/037310 filed on Oct. 16, 2023. The above application is hereby expressly incorporated by reference, in its entirety, into the present application.

### TECHNICAL FIELD

The present disclosure relates to a task supporting device, a task supporting method, and a task supporting system.

### BACKGROUND ART

There are task supporting devices that support tasks to be performed by workers.

As such a task supporting device, Patent Literature 1 discloses a fork positioning supporting device including a camera and an image displaying unit, for example.

The camera captures an image of an area in front of a forklift, and outputs image data indicating the front image to the image displaying unit. The front imaging area to be captured by the camera is an area including the pallet to be carried by the forklift and the forks of the forklift. The image displaying unit displays, on its display, the image indicated by the image data output from the camera.

### Citation List

### Patent Literature

Patent Literature 1: JP 2013-86959 A

### SUMMARY OF INVENTION

### Technical Problem

The fork positioning supporting device disclosed in Patent Literature 1 displays an image of the area including the pallet and the forks on a display, but does not detect whether the forks are correctly positioned with respect to the pallet. For this reason, there is a problem in that a worker or a supervisor who monitors the task may not be able to check whether the positioning task performed by the worker or the positioning task performed by a supervision target has been correctly performed.

The present disclosure has been made to solve the above problem, and aims to obtain a task supporting device that enables a worker or a supervisor monitoring tasks to check whether the task performed by the worker or the task performed by the supervision target has been correctly performed.

### Solution to Problem

A task supporting device according to the present disclosure includes processing circuitry to be a support target; and to acquire text information about a task sound that is a sound indicating the task identified.

### Advantageous Effects of Invention

According to the present disclosure, a worker or a supervisor monitoring a task can check whether the task performed by the worker or the task performed by a supervision target has been correctly performed.

### BRIEF DESCRIPTION OF DRAWINGS

FIG. 1 is a configuration diagram illustrating a task supporting system including a task supporting device 2 according to a first embodiment.

FIG. 2 is a hardware configuration diagram illustrating the hardware of the task supporting device 2 according to the first embodiment.

FIG. 3 is a hardware configuration diagram of a computer in a case where the task supporting device 2 is formed with software, firmware, or the like.

FIG. 4 is a flowchart illustrating a task supporting method as processing procedures to be executed by the task supporting device 2.

FIG. 5 is a configuration diagram illustrating a task supporting system including a task supporting device 2 according to a second embodiment.

FIG. 6 is a hardware configuration diagram illustrating the hardware of the task supporting device 2 according to the second embodiment.

FIG. 7 is a configuration diagram illustrating a task supporting system including a task supporting device 2 according to a third embodiment.

FIG. 8 is a hardware configuration diagram illustrating the hardware of the task supporting device 2 according to the third embodiment.

FIG. 9 is a configuration diagram illustrating a task supporting system including a task supporting device 2 according to a fourth embodiment.

FIG. 10 is a hardware configuration diagram illustrating the hardware of the task supporting device 2 according to the fourth embodiment.

FIG. 11 is a configuration diagram illustrating a task supporting system including a task supporting device 2 according to a fifth embodiment.

FIG. 12 is a hardware configuration diagram illustrating the hardware of the task supporting device 2 according to the fifth embodiment.

FIG. 13 is a configuration diagram illustrating a task supporting system including a task supporting device 2 according to a sixth embodiment.

FIG. 14 is a hardware configuration diagram illustrating the hardware of the task supporting device 2 according to the sixth embodiment.

FIG. 15 is a configuration diagram illustrating a task supporting system including a task supporting device 2 according to a seventh embodiment.

FIG. 16 is a hardware configuration diagram illustrating the hardware of the task supporting device 2 according to the seventh embodiment.

### DESCRIPTION OF EMBODIMENTS

To explain the present disclosure in greater detail, modes for carrying out the disclosure are described below with reference to the accompanying drawings.

### First Embodiment

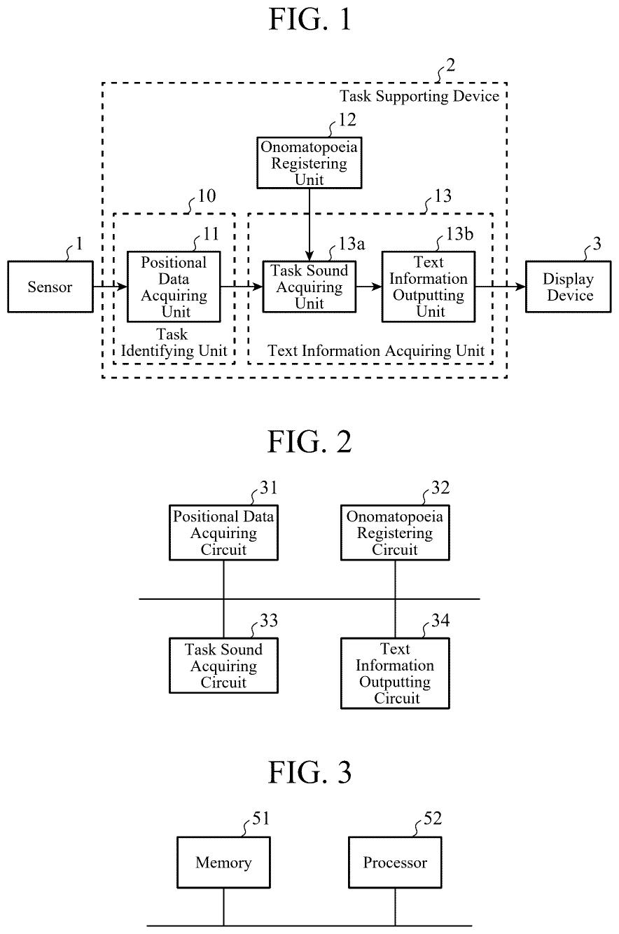

FIG. 1 is a configuration diagram illustrating a task supporting system including a task supporting device 2 according to a first embodiment.

FIG. 2 is a hardware configuration diagram illustrating the hardware of the task supporting device 2 according to the first embodiment.

In FIG. 1, a sensor 1 is formed with a camera or a lidar apparatus, for example.

The sensor 1 detects a task position that is a position where a worker performs task on a task object.

Specifically, the sensor 1 detects, as the task position, the position of a hand of the worker or the position of a foot of the worker with respect to the task object, for example.

The sensor 1 outputs positional data indicating the task position to the task supporting device 2.

When the sensor 1 is formed with a camera, for example, the sensor 1 outputs, as positional data, coordinate data indicating the position of a hand of the worker or the like in an image captured by the camera to the task supporting device 2.

In the task supporting system illustrated in FIG. 1, the sensor 1 detects, as the task position, the position of a hand of the worker or the like with respect to the task object. At this point of time, the sensor 1 may detect the task position, on the basis of task instruction data or the like indicating the task to be next performed by the worker. The task instruction data may be stored in an internal memory of the sensor 1, may be given from the outside the task supporting system, or may be given from the task supporting device 2. For example, the internal memory of the sensor 1 stores a correspondence relationship between one or more tasks that may be performed by the worker and the task positions corresponding to the respective tasks. When such a correspondence relationship is stored in the internal memory, the sensor 1 refers to the internal memory, identifies the task position corresponding to the task indicated by the task instruction data, and outputs positional data indicating the task position to the task supporting device 2.

Alternatively, when the sensor 1 is formed with a camera, the sensor 1 captures an image of the task position corresponding to the task indicated by the task instruction data, and outputs, as positional data, coordinate data indicating the position of a hand of the worker or the like shown in the captured image, to the task supporting device 2.

When a task position is to be detected or identified on the basis of data such as task instruction data prepared beforehand, instead of data such as a captured image acquired during a task, it is also possible to include, as the task position, a position or a region other than the actual task position. As such a region, there is a wider region including the vicinity of the actual task position and the actual task position, for example.

Also, the task supporting system can exclude the sensor 1 when detecting or identifying a task position on the basis of data such as task instruction data prepared beforehand. The data prepared beforehand is static data.

For example, instead of the sensor 1, a positional data acquiring unit 11 included in the task supporting device 2 may detect a task position on the basis of task instruction data. In such a case, an expression such as “the positional data output from the sensor 1” in the description below is replaced with “the positional data identified on the basis of task instruction data”.

Further, the task supporting system can also identify the task to be performed, on the basis of the order of tasks or the like in task processes prepared beforehand, instead of the task position. In that case, the task supporting system may detect a task identifier as an index for identifying the task, instead of detecting the task position. In such a case, an expression such as “the positional data output from the sensor 1”, “the task position indicated by the positional data”, or the like in the description below is replaced with “the task identifier identified on the basis of the task instruction data”, “the task indicated by the task identifier”, or the like. Hereinafter, such means for identifying the task to be a support target will be collectively referred to as the “task identifying unit” in some cases.

Examples of task objects include a product in the middle of production, a product in the middle of assembling, a part to be attached to a product, a product in the middle of disassembling, and a facility such as a factory.

Examples of tasks to be performed by a worker include a task for manufacturing a product, a task for assembling a product, a task to disassemble a product, a task for inspecting a product or equipment, and a task for transporting parts or the like.

The task supporting device 2 includes the positional data acquiring unit 11 as an example of a task identifying unit 10, an onomatopoeia registering unit 12, and a text information acquiring unit 13.

The task supporting device 2 acquires text information about a task sound that is a sound indicating the task when the task is performed at the task position indicated by the positional data output from the sensor 1.

The task supporting device 2 outputs the text information about the task sound to a display device 3.

In the task supporting system illustrated in FIG. 1, the task supporting device 2 acquires text information about a task sound, and outputs the text information about the task sound to the display device 3. The task supporting device 2 may further have a function of performing task process management or a function of performing task safety management. To enable these functions, the task supporting device 2 stores a process management table of the task, a task instruction manual for issuing task instructions, a reference catalog, a manual related to the task, design data of the task object, three-dimensional data indicating the outer shape of the task object, or map data indicating the position of the task object, for example.

The display device 3 is formed with a smartphone, a tablet, or augmented reality (AR) glasses, for example.

The display device 3 displays text indicating a task sound in accordance with text information output from the task supporting device 2.

The task identifying unit 10 includes the positional data acquiring unit 11.

The task identifying unit 10 identifies the task to be the support target.

The positional data acquiring unit 11 is formed with a positional data acquiring circuit 31 shown in FIG. 2, for example.

The positional data acquiring unit 11 acquires positional data indicating the task position from the sensor 1. The task position may be detected by the sensor 1 on the basis of task instruction data, or may be detected independently of the task instruction data. Note that the positional data acquiring unit 11 can also acquire positional data indicating the task position on the basis of the task instruction data as described above.

The positional data acquiring unit 11 outputs the positional data to the text information acquiring unit 13.

The onomatopoeia registering unit 12 is formed with an onomatopoeia registering circuit 32 shown in FIG. 2, for example.

The onomatopoeia registering unit 12 registers onomatopoeias (imitative sound) corresponding to the task sounds to be generated during tasks that may be performed on the task object. The onomatopoeia registering unit 12 is a database in which task sounds corresponding to the tasks to be performed in the respective processes of a plurality of task processes indicated by task instruction data or the like, or onomatopoeias corresponding to the task sounds of the tasks to be performed at the respective task positions when tasks are performed at a plurality of task positions in accordance with the task processes prepared beforehand for the task object are registered, for example.

In the task supporting device 2 illustrated in FIG. 1, onomatopoeias corresponding to task sounds to be generated when tasks are performed in the respective task processes or at the respective task positions are registered in the onomatopoeia registering unit 12. Note that this is merely an example, and actual task sounds to be generated when the tasks are performed may be registered in the onomatopoeia registering unit 12. Examples of actual task sounds include task sounds collected by a microphone when a certain task is performed.

Also, instead of the onomatopoeias corresponding to the task sounds to be generated when the tasks are performed, text information about the task sounds to be generated when the tasks are performed may be registered in the onomatopoeia registering unit 12.

The task supporting device 2 illustrated in FIG. 1 includes the onomatopoeia registering unit 12 therein. Note that this is merely an example, and the onomatopoeia registering unit 12 may be provided outside the task supporting device 2.

The text information acquiring unit 13 includes a task sound acquiring unit 13a and a text information outputting unit 13b.

The text information acquiring unit 13 acquires the positional data from the positional data acquiring unit 11.

The text information acquiring unit 13 acquires the text information about the task sound that is the sound indicating the task when the task is performed at the task position indicated by the positional data.

The text information acquiring unit 13 outputs the text information about the task sound to the display device 3.

The task sound acquiring unit 13a is formed with a task sound acquiring circuit 33 shown in FIG. 2, for example.

The task sound acquiring unit 13a acquires the positional data from the positional data acquiring unit 11.

On the basis of the positional data, the task sound acquiring unit 13a acquires the task sound to be generated when the task is performed by a worker.

Specifically, the task sound acquiring unit 13a acquires, from the onomatopoeia registering unit 12, the onomatopoeia corresponding to the task position indicated by the positional data as the task sound to be generated when the task is performed by a worker.

The task sound acquiring unit 13a outputs sound data indicating the onomatopoeia to the text information outputting unit 13b.

In the task supporting device 2 illustrated in FIG. 1, the task sound acquiring unit 13a acquires, from the onomatopoeia registering unit 12, the onomatopoeia corresponding to the task position indicated by the positional data as the task sound to be generated when the task is performed by a worker. Note that this is merely an example, and the task sound acquiring unit 13a may give the positional data to a trained model (not shown), and acquire, from the trained model, the onomatopoeia corresponding to the task position indicated by the positional data.

The trained model learns the onomatopoeia corresponding to the task position when the positional data and training data indicating the onomatopoeia corresponding to the task position indicated by the positional data are given at the time of training.

When the positional data is given from the task sound acquiring unit 13a at the time of inference, the trained model outputs the sound data indicating the onomatopoeia corresponding to the task position indicated by the positional data, to the display device 3.

In the task supporting device 2 illustrated in FIG. 1, the task sound acquiring unit 13a acquires, from the onomatopoeia registering unit 12, the onomatopoeia corresponding to the task position indicated by the positional data as the task sound to be generated when the task is performed by a worker. When text information about the task sound corresponding to the task position, instead of the onomatopoeia corresponding to the task position, is registered in the onomatopoeia registering unit 12, the task sound acquiring unit 13a acquires the text information about the task sound corresponding to the task position indicated by the positional data from the onomatopoeia registering unit 12, and outputs the text information to the text information outputting unit 13b.

The text information outputting unit 13b is formed with a text information outputting circuit 34 shown in FIG. 2, for example.

The text information outputting unit 13b acquires the sound data indicating the onomatopoeia from the task sound acquiring unit 13a.

The text information outputting unit 13b converts the onomatopoeia indicated by the sound data into text information.

The text information outputting unit 13b outputs the text information to the display device 3.

In the task supporting device 2 illustrated in FIG. 1, the text information outputting unit 13b acquires sound data indicating an onomatopoeia from the task sound acquiring unit 13a. When text information about a task sound is output from the task sound acquiring unit 13a, the text information outputting unit 13b acquires the text information from the task sound acquiring unit 13a, and outputs the text information to the display device 3.

In the task supporting device 2 illustrated in FIG. 1, the text information outputting unit 13b outputs text information to the display device 3. Note that this is merely an example, and the text information outputting unit 13b may output sound data of the onomatopoeia indicated by text information to a speaker (not shown), for example.

In FIG. 1, it is assumed that each of the positional data acquiring unit 11, the onomatopoeia registering unit 12, the task sound acquiring unit 13a, and the text information outputting unit 13b, which are components of the task supporting device 2, is formed with dedicated hardware as illustrated in FIG. 2. That is, it is assumed that the task supporting device 2 is formed with the positional data acquiring circuit 31, the onomatopoeia registering circuit 32, the task sound acquiring circuit 33, and the text information outputting circuit 34.

Here, the onomatopoeia registering circuit 32 may be a nonvolatile or volatile semiconductor memory such as a random access memory (RAM), a read only memory (ROM), a flash memory, an erasable programmable read only memory (EPROM), or an electrically erasable programmable read only memory (EEPROM), a magnetic disk, a flexible disk, an optical disk, a compact disk, a mini disk, or a digital versatile disc (DVD), for example.

Meanwhile, each of the positional data acquiring circuit 31, the task sound acquiring circuit 33, and the text information outputting circuit 34 is a single circuit, a composite circuit, a programmed processor, a parallel-programmed processor, an application specific integrated circuit (ASIC), a field-programmable gate array (FPGA), or a combination thereof, for example.

The components of the task supporting device 2 are not necessarily formed with dedicated hardware, but the task supporting device 2 may be formed with software, firmware, or a combination of software and firmware.

Software or firmware is stored as a program in memory of a computer. A computer means hardware that executes a program, and is a central processing unit (CPU), a graphics processing unit (GPU), a central processor, a processing unit, an arithmetic unit, a microprocessor, a microcomputer, a processor, or a digital signal processor (DSP), for example.

FIG. 3 is a hardware configuration diagram of a computer in a case where the task supporting device 2 is formed with software, firmware, or the like.

In a case where the task supporting device 2 is formed with software, firmware, or the like, the onomatopoeia registering unit 12 is formed in memory 51 of the computer. A program for causing a computer to execute the respective processing procedures performed in the positional data acquiring unit 11, the task sound acquiring unit 13a, and the text information outputting unit 13b is stored in the memory 51. A processor 52 of the computer then executes the program stored in the memory 51.

Further, FIG. 2 illustrates an example in which each of the components of the task supporting device 2 is formed with dedicated hardware, and FIG. 3 illustrates an example in which the task supporting device 2 is formed with software, firmware, or the like. Note that this is merely an example, and some components in the task supporting device 2 may be formed with dedicated hardware while the remaining components are formed with software, firmware, or the like.

Next, an operation to be performed by the task supporting system illustrated in FIG. 1 is described.

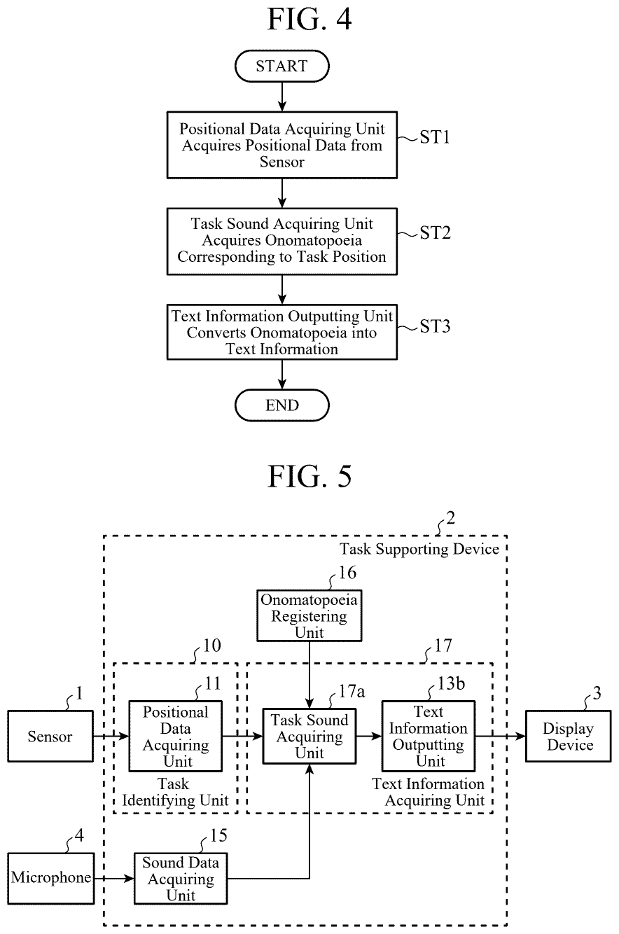

FIG. 4 is a flowchart illustrating a task supporting method as processing procedures to be executed by the task supporting device 2.

The sensor 1 detects a task position that is a position where a worker performs task on a task object.

Specifically, the sensor 1 detects, as the task position, the position of a hand of the worker with respect to the task object, for example.

The sensor 1 may detect the task position on the basis of task instruction data as described above.

The positional data acquiring unit 11 of the task supporting device 2 acquires positional data indicating the task position from the sensor 1 (step ST1 in FIG. 4). The positional data acquiring unit 11 may acquire the positional data indicating the task position on the basis of task instruction data as described above. Also, the positional data acquiring unit 11 may acquire the task identifier for identifying the task on the basis of the task instruction data as described above.

The positional data acquiring unit 11 outputs either the positional data or the task identifier to the task sound acquiring unit 13a.

The onomatopoeias corresponding to the task sounds to be generated during tasks that may be performed on the task object are registered in the onomatopoeia registering unit 12. In the onomatopoeia registering unit 12, task sounds corresponding to the tasks to be performed in the respective processes of a plurality of task processes indicated by task instruction data or the like, or onomatopoeias corresponding to the task sounds of the tasks to be performed at the respective task positions when tasks are performed at a plurality of task positions in accordance with the task processes prepared beforehand for the task object are registered, for example.

When there are three tasks (1) to (3) as the tasks to be performed on the task object, for example, the task (1) is a task for tightening a screw to a position A of the task object with an electric screwdriver, for example, the task (2) is a task for fitting a connector to a position B of the task object, for example, and the task (3) is a task for making a hole at a position C of the task object with an electric drill, for example.

In such a case, the onomatopoeias as shown below are registered in the onomatopoeia registering unit 12 as the onomatopoeias corresponding to the task sounds to be generated when tasks are performed as the respective tasks (1) to (3).
Task (1)→Onomatopoeia “boooom”
Task (2)→Onomatopoeia “click”
Task (3)→Onomatopoeia “squeak, squeak”

The task sound acquiring unit 13a acquires either the positional data or the task identifier from the positional data acquiring unit 11.

The task sound acquiring unit 13a acquires, from the onomatopoeia registering unit 12, the onomatopoeia corresponding to the task to be performed at the task position indicated by the positional data or the task indicated by the task identifier as the task sound to be generated when the task is performed by the worker (step ST2 in FIG. 4).

When the task to be performed at the task position indicated by the positional data or the task indicated by the task identifier is the task (1), for example, the task sound acquiring unit 13a acquires “boooom” as the onomatopoeia.

When the task to be performed at the task position indicated by the positional data or the task indicated by the task identifier is the task (2), for example, the task sound acquiring unit 13a acquires “click” as the onomatopoeia.

When the task to be performed at the task position indicated by the positional data or the task indicated by the task identifier is the task (3), for example, the task sound acquiring unit 13a acquires “squeak, squeak” as the onomatopoeia.

The task sound acquiring unit 13a outputs sound data indicating the acquired onomatopoeia to the text information outputting unit 13b. Note that the method of specifying the task is merely an example, and is not limited to the above method, and some other known method may be used.

The text information outputting unit 13b acquires the sound data indicating the onomatopoeia from the task sound acquiring unit 13a.

The text information outputting unit 13b converts the onomatopoeia indicated by the sound data into text information (step ST3 in FIG. 4). The process of converting an onomatopoeia into text information is a known technique, and therefore, detailed explanation thereof is not made herein.

The text information outputting unit 13b outputs the text information to the display device 3.

As a result, the text information is displayed on the display device 3.

When the task to be performed at the task position indicated by the positional data or the task indicated by the task identifier is the task (1), for example, the text information indicating “boooom” is displayed on the display device 3. The text information on the display device 3 may be displayed as AR display, using an onomatopoetic expression as in a cartoon or a balloon as in a cartoon, for example. The display position may be the task position indicated by the positional data, or may be a position determined beforehand as a task sound displaying position of the task to be performed at the task position indicated by the positional data or the task indicated by the task identifier, for example. Also, a position that is in the vicinity of the task position and does not interfere with the task of the worker may be determined and displayed.

When a sound similar to the displayed onomatopoeia “boooom” is generated when the worker actually performs the task, the worker can determine that he/she has correctly performed the task. When a sound not similar to “boooom” is generated when the worker actually performs the task, the worker can determine that he/she has not correctly performed the task.

In the first embodiment, the task supporting device 2 includes: the task identifying unit 10 that identifies the task to be the support target; and the text information acquiring unit 13 that acquires text information about a task sound that is a sound indicating the task identified by the task identifying unit 10. Accordingly, with the task supporting device 2, the worker or a supervisor monitoring the task can check whether the task performed by the worker or the task performed by a supervision target has been correctly performed.

### Second Embodiment

A task supporting device 2 including a sound data acquiring unit 15 that acquires sound data indicating a task sound from a microphone 4 that collects the task sound generated when a worker performs a task is now described.

FIG. 5 is a configuration diagram illustrating a task supporting system including the task supporting device 2 according to a second embodiment. In FIG. 5, the same reference numerals as those in FIG. 1 denote the same or corresponding components, and therefore, detailed explanation of these components is not made herein.

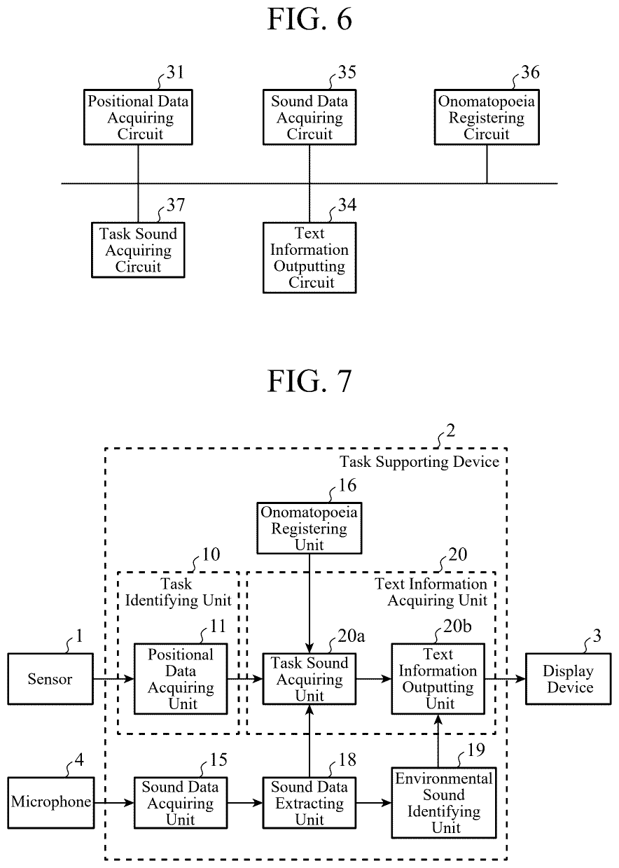

FIG. 6 is a hardware configuration diagram illustrating the hardware of the task supporting device 2 according to the second embodiment. In FIG. 6, the same reference numerals as those in FIG. 2 denote the same or corresponding components, and therefore, detailed explanation of these components is not made herein.

The microphone 4 collects the task sound generated when a worker performs task.

The microphone 4 outputs sound data indicating the task sound to the task supporting device 2.

The task supporting device 2 illustrated in FIG. 5 includes a positional data acquiring unit 11, the sound data acquiring unit 15, an onomatopoeia registering unit 16, and a text information acquiring unit 17.

The sound data acquiring unit 15 is formed with a sound data acquiring circuit 35 shown in FIG. 6, for example.

The sound data acquiring unit 15 acquires sound data indicating a task sound from the microphone 4.

The sound data acquiring unit 15 outputs the sound data indicating the task sound to the text information acquiring unit 17.

The onomatopoeia registering unit 16 is formed with an onomatopoeia registering circuit 36 shown in FIG. 6, for example.

The onomatopoeia registering unit 16 is a database in which onomatopoeias corresponding to task sounds when tasks are performed at the respective task positions for a task object are registered.

As the onomatopoeias corresponding to task sounds, the onomatopoeias corresponding to the task sounds to be generated when tasks are correctly performed, and the onomatopoeias corresponding to the task sounds to be generated when the tasks are not correctly performed are registered in the onomatopoeia registering unit 16.

In the task supporting device 2 illustrated in FIG. 5, the onomatopoeias corresponding to the task sounds to be generated during tasks that may be performed on the task object are registered in the onomatopoeia registering unit 16. Note that this is merely an example, and text information about the task sounds to be generated when tasks are correctly performed and text information about the task sounds to be generated when the tasks are not correctly performed may be registered in the onomatopoeia registering unit 16.

The task supporting device 2 illustrated in FIG. 5 includes the onomatopoeia registering unit 16 therein. Note that this is merely an example, and the onomatopoeia registering unit 16 may be provided outside the task supporting device 2.

The text information acquiring unit 17 includes a task sound acquiring unit 17a and a text information outputting unit 13b.

The text information acquiring unit 17 acquires either positional data or a task identifier from the positional data acquiring unit 11, and acquires sound data from the sound data acquiring unit 15.

The text information acquiring unit 17 may acquire, from the onomatopoeia registering unit 16, the onomatopoeia corresponding to the task sound indicated by the sound data as the onomatopoeia corresponding to the task sound of the task to be performed at the task position indicated by the positional data or the task indicated by the task identifier, for example.

The text information acquiring unit 17 converts the onomatopoeia into text information, and outputs the text information to a display device 3.

The task sound acquiring unit 17a is formed with a task sound acquiring circuit 37 shown in FIG. 6, for example.

The task sound acquiring unit 17a acquires either positional data or a task identifier from the positional data acquiring unit 11, and acquires sound data from the sound data acquiring unit 15.

The task sound acquiring unit 17a acquires, from the onomatopoeia registering unit 16, the onomatopoeia corresponding to the task sound indicated by the sound data as the onomatopoeia corresponding to the task sound of the task to be performed at the task position indicated by the positional data or the task indicated by the task identifier.

The task sound acquiring unit 17a outputs sound data indicating the acquired onomatopoeia to the text information outputting unit 13b.

In FIG. 5, it is assumed that each of the positional data acquiring unit 11, the sound data acquiring unit 15, the onomatopoeia registering unit 16, the task sound acquiring unit 17a, and the text information outputting unit 13b, which are components of the task supporting device 2, is formed with dedicated hardware as illustrated in FIG. 6. That is, it is assumed that the task supporting device 2 is formed with a positional data acquiring circuit 31, the sound data acquiring circuit 35, the onomatopoeia registering circuit 36, the task sound acquiring circuit 37, and a text information outputting circuit 34.

Here, the onomatopoeia registering circuit 36 may be a nonvolatile or volatile semiconductor memory such as a RAM, a ROM, a flash memory, an EPROM, or an EEPROM, a magnetic disk, a flexible disk, an optical disk, a compact disk, a mini disk, or a DVD, for example.

Meanwhile, each of the positional data acquiring circuit 31, the sound data acquiring circuit 35, the task sound acquiring circuit 37, and the text information outputting circuit 34 is a single circuit, a composite circuit, a programmed processor, a parallel-programmed processor, an ASIC, an FPGA, or a combination thereof, for example.

The components of the task supporting device 2 are not necessarily formed with dedicated hardware, but the task supporting device 2 may be formed with software, firmware, or a combination of software and firmware.

In a case where the task supporting device 2 is formed with software, firmware, or the like, the onomatopoeia registering unit 16 is formed in the memory 51 shown in FIG. 3. A program for causing a computer to execute the respective processing procedures performed in the positional data acquiring unit 11, the sound data acquiring unit 15, the task sound acquiring unit 17a, and the text information outputting unit 13b is stored in the memory 51. The processor 52 shown in FIG. 3 then executes the program stored in the memory 51.

Further, FIG. 6 illustrates an example in which each of the components of the task supporting device 2 is formed with dedicated hardware, and FIG. 3 illustrates an example in which the task supporting device 2 is formed with software, firmware, or the like. Note that this is merely an example, and some components in the task supporting device 2 may be formed with dedicated hardware while the remaining components are formed with software, firmware, or the like.

Next, an operation to be performed by the task supporting system illustrated in FIG. 5 is described. Note that it is the same as the task supporting system illustrated in FIG. 1, except for the microphone 4, the sound data acquiring unit 15, the onomatopoeia registering unit 16, and the task sound acquiring unit 17a. Therefore, only the operations to be performed by the microphone 4, the sound data acquiring unit 15, the onomatopoeia registering unit 16, and the task sound acquiring unit 17a are described herein.

The microphone 4 collects a task sound generated when a task is performed, and outputs sound data indicating the task sound to the task supporting device 2.

The sound data acquiring unit 15 of the task supporting device 2 acquires the sound data indicating the task sound from the microphone 4.

The sound data acquiring unit 15 outputs the sound data indicating the task sound to the task sound acquiring unit 17a.

The onomatopoeias corresponding to task sounds are registered in the onomatopoeia registering unit 16.

As the onomatopoeias corresponding to task sounds, the onomatopoeias corresponding to the task sounds to be generated when tasks are correctly performed, and the onomatopoeias corresponding to the task sounds to be generated when the tasks are not correctly performed are registered in the onomatopoeia registering unit 16.

When there are two tasks (1) and (2) as the tasks to be performed on the task object, for example, the task (1) is a task for tightening a screw to a position A of the task object with an electric screwdriver, for example, and the task (2) is a task for fitting a connector to a position B of the task object, for example.

In such a case, the onomatopoeias as shown below are registered in the onomatopoeia registering unit 16 as the onomatopoeias corresponding to the task sounds of the respective tasks (1) and (2).
Task (1)
   →Onomatopoeia “boooom” to be generated when the task is correctly performed
   →Onomatopoeia “creak, creak” to be generated when the task is not correctly performed
Task (2)
   →Onomatopoeia “click” to be generated when the task is correctly performed
   →Onomatopoeia “swish” to be generated when the task is not correctly performed

The task sound acquiring unit 17a acquires either positional data or a task identifier from the positional data acquiring unit 11, and acquires sound data from the sound data acquiring unit 15.

The task sound acquiring unit 17a acquires, from the onomatopoeia registering unit 16, the onomatopoeia that corresponds to the task to be performed at the task position indicated by the positional data or the task indicated by the task identifier, and corresponds to the task sound indicated by the sound data, as the task sound to be generated when the task is performed by a worker.

Specifically, when the identified task is the task (1), for example, the task sound acquiring unit 17a compares the task sound indicated by the sound data with each of the onomatopoeia “boooom” and the onomatopoeia “creak, creak”.

When the task sound indicated by the sound data is similar to the onomatopoeia “boooom”, the task sound acquiring unit 17a determines that the task has been correctly performed. When the task sound indicated by the sound data is similar to the onomatopoeia “creak, creak”, the task sound acquiring unit 17a determines that the task has not been correctly performed.

Accordingly, when the identified task is the task (1), and the task has been correctly performed, for example, the task sound acquiring unit 17a acquires “boooom” as the onomatopoeia from the onomatopoeia registering unit 16.

When the identified task is the task (1), and the task has not been correctly performed, for example, the task sound acquiring unit 17a acquires “creak, creak” as the onomatopoeia from the onomatopoeia registering unit 16.

When the identified task is the task (2), for example, the task sound acquiring unit 17a compares the task sound indicated by the sound data with each of the onomatopoeia “click” and the onomatopoeia “swish”.

When the task sound indicated by the sound data is similar to the onomatopoeia “click”, the task sound acquiring unit 17a determines that the task has been correctly performed. When the task sound indicated by the sound data is similar to the onomatopoeia “swish”, the task sound acquiring unit 17a determines that the task has not been correctly performed.

Accordingly, when the identified task is the task (2), and the task has been correctly performed, for example, the task sound acquiring unit 17a acquires “click” as the onomatopoeia from the onomatopoeia registering unit 16.

When the identified task is the task (2), and the task has not been correctly performed, for example, the task sound acquiring unit 17a acquires “swish” as the onomatopoeia from the onomatopoeia registering unit 16.

The task sound acquiring unit 17a outputs sound data indicating the acquired onomatopoeia to the text information outputting unit 13b.

The text information outputting unit 13b acquires the sound data indicating the onomatopoeia from the task sound acquiring unit 17a.

The text information outputting unit 13b converts the onomatopoeia indicated by the sound data into text information, and outputs the text information to the display device 3.

In a case where the task has not been correctly performed, the text information outputting unit 13b may convert the text information into text information in a different format from that of the text information to be generated when is correctly performed, to facilitate distinction from a case where the task has been correctly performed. Examples of the text information in a different format include text information in a different color from that of the text information to be generated when the task is correctly performed, text information in a different typeface from that of the text information to be generated when the task is correctly performed, and text information of a different size from that of the text information to be generated when the task is correctly performed.

The text information outputting unit 13b may display the text information in a cartoon-like manner on the display device 3. For example, the text information may be displayed as AR display, using an onomatopoetic expression as in a cartoon or a balloon as in a cartoon.

In the second embodiment described so far, the onomatopoeias corresponding to the task sounds to be generated when tasks are correctly performed, and the onomatopoeias corresponding to the task sounds to be generated when the tasks are not correctly performed are registered in the onomatopoeia registering unit 16. The task supporting device 2 includes the sound data acquiring unit 15 that acquires sound data indicating a task sound from the microphone 4 that collects the task sound generated when a task is performed. Meanwhile, the text information acquiring unit 17 of the task supporting device 2 is designed to acquire, from the onomatopoeia registering unit 16, the onomatopoeia corresponding to the task sound indicated by sound data acquired by the sound data acquiring unit 15 as the onomatopoeia corresponding to the task sound of a predetermined task. Accordingly, with the task supporting device 2, the worker or the supervisor monitoring the task can check whether the task performed by the worker or the task performed by the supervision target has been correctly performed.

In the task supporting system illustrated in FIG. 5, the onomatopoeias corresponding to the task sounds to be generated when tasks are not correctly performed are registered in the onomatopoeia registering unit 16. As the onomatopoeias corresponding to task sounds to be generated when tasks are not correctly performed, onomatopoeias completely different from the onomatopoeias corresponding to the task sounds to be generated when the tasks are correctly performed may be registered. Examples of the completely different onomatopoeias include an onomatopoeia “clang” to be generated when a tool is dropped on the floor, an onomatopoeia “snap” to be generated when a part is broken, and an onomatopoeia “rumble, rumble” to be generated when a cart approaches the task position.

### Third Embodiment

A third embodiment concerns a task supporting device 2 including a sound data extracting unit 18 that extracts sound data indicating a task sound from sound data acquired by a sound data acquiring unit 15 when the sound data acquired by the sound data acquiring unit 15 includes sound data indicating a task sound and sound data indicating an environmental sound.

FIG. 7 is a configuration diagram illustrating a task supporting system including the task supporting device 2 according to the third embodiment. In FIG. 7, the same reference numerals as those in FIG. 1 and FIG. 5 denote the same or corresponding components, and therefore, detailed explanation of them is not made herein.

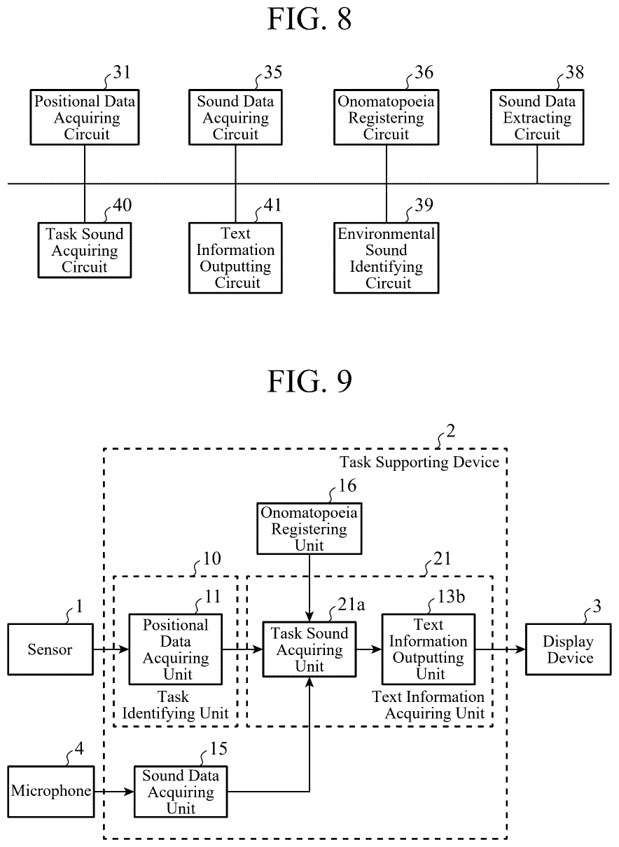

FIG. 8 is a hardware configuration diagram illustrating the hardware of the task supporting device 2 according to the third embodiment. In FIG. 8, the same reference numerals as those in FIG. 2 and FIG. 6 denote the same or corresponding components, and therefore, detailed explanation of them is not made herein.

The task supporting device 2 illustrated in FIG. 7 includes a positional data acquiring unit 11, the sound data acquiring unit 15, an onomatopoeia registering unit 16, the sound data extracting unit 18, an environmental sound identifying unit 19, and a text information acquiring unit 20.

The sound data extracting unit 18 is formed with a sound data extracting circuit 38 shown in FIG. 8, for example.

The sound data extracting unit 18 acquires, from the sound data acquiring unit 15, sound data indicating a task sound generated when a task is performed.

When the sound data includes sound data indicating the task sound and sound data indicating an environmental sound, the sound data extracting unit 18 extracts the sound data indicating the task sound from sound data acquired by the sound data acquiring unit 15, and outputs the sound data indicating the task sound to the text information acquiring unit 20.

Also, when the sound data includes sound data indicating the task sound and sound data indicating an environmental sound, the sound data extracting unit 18 extracts the sound data indicating the environmental sound from the sound data acquired by the sound data acquiring unit 15, and outputs the sound data indicating the environmental sound to the environmental sound identifying unit 19.

The environmental sound identifying unit 19 is formed with an environmental sound identifying circuit 39 shown in FIG. 8, for example.

The environmental sound identifying unit 19 acquires the sound data indicating the environmental sound from the sound data extracting unit 18.

The environmental sound identifying unit 19 identifies the onomatopoeia corresponding to the environmental sound indicated by the sound data.

The environmental sound identifying unit 19 outputs sound data indicating the onomatopoeia corresponding to the environmental sound to the text information acquiring unit 20.

The text information acquiring unit 20 includes a task sound acquiring unit 20a and a text information outputting unit 20b.

The text information acquiring unit 20 acquires either positional data or a task identifier from the positional data acquiring unit 11, acquires the sound data indicating the task sound from the sound data extracting unit 18, and acquires the sound data indicating the onomatopoeia corresponding to the environmental sound from the environmental sound identifying unit 19.

The text information acquiring unit 20 acquires, from the onomatopoeia registering unit 16, the onomatopoeia corresponding to the task sound indicated by the sound data extracted by the sound data extracting unit 18 as the onomatopoeia corresponding to the task sound of a predetermined task.

The text information acquiring unit 20 converts the onomatopoeia corresponding to the task sound into text information, and converts the onomatopoeia corresponding to the environmental sound into text information.

The text information acquiring unit 20 outputs both pieces of the text information to a display device 3.

The task sound acquiring unit 20a is formed with a task sound acquiring circuit 40 shown in FIG. 8, for example.

The task sound acquiring unit 20a acquires either positional data or a task identifier from the positional data acquiring unit 11, and acquires the sound data indicating the task sound from the sound data extracting unit 18.

The task sound acquiring unit 20a acquires, from the onomatopoeia registering unit 16, the onomatopoeia corresponding to the task sound indicated by the sound data extracted by the sound data extracting unit 18 as the onomatopoeia corresponding to the task sound of the task.

The task sound acquiring unit 20a outputs sound data indicating the onomatopoeia corresponding to the task sound, to the text information outputting unit 20b.

The text information outputting unit 20b is formed with a text information outputting circuit 41 shown in FIG. 8, for example.

The text information outputting unit 20b acquires the sound data indicating the onomatopoeia from the task sound acquiring unit 20a, and acquires the sound data indicating the onomatopoeia corresponding to the environmental sound from the environmental sound identifying unit 19.

The text information outputting unit 20b converts the onomatopoeia corresponding to the task sound into text information, and converts the onomatopoeia corresponding to the environmental sound into text information.

The text information outputting unit 20b outputs both pieces of the text information to the display device 3.

In FIG. 7, it is assumed that each of the positional data acquiring unit 11, the sound data acquiring unit 15, the onomatopoeia registering unit 16, the sound data extracting unit 18, the environmental sound identifying unit 19, the task sound acquiring unit 20a, and the text information outputting unit 20b, which are components of the task supporting device 2, is formed with dedicated hardware as illustrated in FIG. 8. That is, it is assumed that the task supporting device 2 is formed with a positional data acquiring circuit 31, a sound data acquiring circuit 35, an onomatopoeia registering circuit 36, the sound data extracting circuit 38, the environmental sound identifying circuit 39, the task sound acquiring circuit 40, and the text information outputting circuit 41.

Each of the positional data acquiring circuit 31, the sound data acquiring circuit 35, the sound data extracting circuit 38, the environmental sound identifying circuit 39, the task sound acquiring circuit 40, and the text information outputting circuit 41 is a single circuit, a composite circuit, a programmed processor, a parallel-programmed processor, an ASIC, an FPGA, or a combination thereof, for example.

The components of the task supporting device 2 are not necessarily formed with dedicated hardware, but the task supporting device 2 may be formed with software, firmware, or a combination of software and firmware.

In a case where the task supporting device 2 is formed with software, firmware, or the like, the onomatopoeia registering unit 16 is formed in the memory 51 shown in FIG. 3. A program for causing a computer to execute the respective processing procedures performed in the positional data acquiring unit 11, the sound data acquiring unit 15, the sound data extracting unit 18, the environmental sound identifying unit 19, the task sound acquiring unit 20a, and the text information outputting unit 20b is stored in the memory 51. The processor 52 shown in FIG. 3 then executes the program stored in the memory 51.

Further, FIG. 8 illustrates an example in which each of the components of the task supporting device 2 is formed with dedicated hardware, and FIG. 3 illustrates an example in which the task supporting device 2 is formed with software, firmware, or the like. Note that this is merely an example, and some components in the task supporting device 2 may be formed with dedicated hardware while the remaining components are formed with software, firmware, or the like.

Next, an operation to be performed by the task supporting system illustrated in FIG. 7 is described. Note that it is similar to the task supporting system illustrated in FIG. 5 except for the sound data extracting unit 18, the environmental sound identifying unit 19, and the text information acquiring unit 20. Therefore, operations to be performed by the sound data extracting unit 18, the environmental sound identifying unit 19, and the text information acquiring unit 20 are mainly described herein.

The microphone 4 collects the task sound generated when a task is performed.

Also, if an environmental sound is generated when the task is performed, the microphone 4 collects the environmental sound together with the task sound. Examples of the environmental sound include a sound from air-conditioning equipment in a room where the task is performed, and a task sound associated with some other task.

The microphone 4 outputs sound data indicating the task sound and the environmental sound to the task supporting device 2.

The sound data acquiring unit 15 of the task supporting device 2 acquires the sound data from the microphone 4, and outputs the sound data to the sound data extracting unit 18.

The sound data extracting unit 18 acquires the sound data from the sound data acquiring unit 15.

When the acquired sound data includes sound data indicating the task sound and sound data indicating the environmental sound, the sound data extracting unit 18 extracts the sound data indicating the task sound from the acquired sound data.

Also, the sound data extracting unit 18 extracts the sound data indicating the environmental sound from the acquired sound data.

Each of the process of extracting the sound data indicating the task sound and the process of extracting the sound data indicating the environmental sound is a known technique, and therefore, detailed explanation thereof is not made herein. For example, it is possible to extract the sound data indicating the task sound or the sound data indicating the environmental sound, on the basis of a difference between the orientation direction of the task sound with respect to the microphone 4 and the orientation direction of the environmental sound with respect to the microphone 4.

The sound data extracting unit 18 outputs the sound data indicating the task sound to the task sound acquiring unit 20a, and outputs the sound data indicating the environmental sound to the environmental sound identifying unit 19.

The task sound acquiring unit 20a acquires either positional data or a task identifier from the positional data acquiring unit 11, and acquires the sound data indicating the task sound from the sound data extracting unit 18.

Like the task sound acquiring unit 17a shown in FIG. 5, the task sound acquiring unit 20a acquires, from the onomatopoeia registering unit 16, the onomatopoeia that corresponds to the task to be performed at the task position indicated by the positional data or the task indicated by the task identifier, and corresponds to the task sound indicated by the sound data, as the onomatopoeia corresponding to the task sound of the task.

The task sound acquiring unit 20a outputs sound data indicating the onomatopoeia corresponding to the task sound, to the text information outputting unit 20b.

The environmental sound identifying unit 19 acquires the sound data indicating the environmental sound from the sound data extracting unit 18.

The environmental sound identifying unit 19 identifies the onomatopoeia corresponding to the environmental sound indicated by the sound data.

For example, when various environmental sounds and onomatopoeias corresponding to the various environmental sounds are stored in an internal memory of the environmental sound identifying unit 19, the environmental sound identifying unit 19 identifies the environmental sound corresponding to the environmental sound indicated by the sound data, by comparing the environmental sound indicated by the sound data with the various environmental sounds stored in the internal memory. The environmental sound identifying unit 19 then acquires the onomatopoeia corresponding to the identified environmental sound from the internal memory.

The environmental sound identifying unit 19 outputs sound data indicating the onomatopoeia corresponding to the environmental sound to the text information outputting unit 20b.

The text information outputting unit 20b acquires sound data indicating an onomatopoeia from at least one of the task sound acquiring unit 20a or the environmental sound identifying unit 19.

The text information outputting unit 20b converts the onomatopoeia indicated by the acquired sound data into text information. The process of converting an onomatopoeia into text information is a known technique, and therefore, detailed explanation thereof is not made herein.

The text information outputting unit 20b outputs the text information to the display device 3. As a result, the text information is displayed on the display device 3.

In the third embodiment described so far, the onomatopoeias corresponding to the task sounds to be generated when tasks are correctly performed, and the onomatopoeias corresponding to the task sounds to be generated when the tasks are not correctly performed are registered in the onomatopoeia registering unit 16. The task supporting device 2 includes: the sound data acquiring unit 15 that acquires sound data indicating a task sound from the microphone 4 that collects the task sound generated when a task is performed; and the sound data extracting unit 18 that extracts the sound data indicating the task sound from the sound data acquired by the sound data acquiring unit 15, when the sound data acquired by the sound data acquiring unit 15 includes the sound data indicating the task sound generated when the task is performed and sound data indicating an environmental sound. Meanwhile, the text information acquiring unit 20 of the task supporting device 2 is designed to acquire, from the onomatopoeia registering unit 16, the onomatopoeia corresponding to the task sound indicated by sound data extracted by the sound data extracting unit 18 as the onomatopoeia corresponding to the task sound to be generated when the task is performed at the task position indicated by positional data. Accordingly, with the task supporting device 2, the worker or the supervisor monitoring the task can check whether the task performed by the worker or the task performed by the supervision target has been correctly performed, even when an environmental sound has been generated in addition to a task sound.

### Fourth Embodiment

A fourth embodiment concerns a task supporting device including a text information acquiring unit 21 that identifies the onomatopoeia corresponding to sound data acquired by a sound data acquiring unit 15 as the task sound of the task to be performed at the task position indicated by positional data or the task indicated by a task identifier, when the onomatopoeia corresponding to the task sound indicated by the sound data acquired by the sound data acquiring unit 15 is not registered in an onomatopoeia registering unit 16.

FIG. 9 is a configuration diagram illustrating a task supporting system including the task supporting device 2 according to the fourth embodiment. In FIG. 9, the same reference numerals as those in FIG. 1, FIG. 5, and FIG. 7 denote the same or corresponding components, and therefore, detailed explanation of them is not made herein.

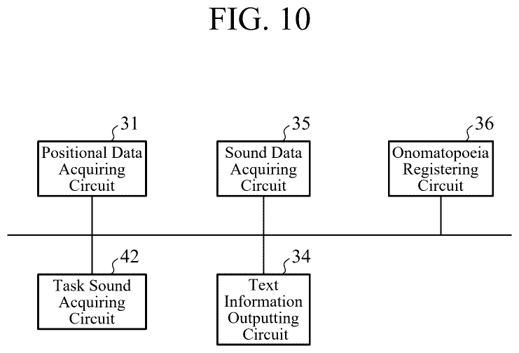

FIG. 10 is a hardware configuration diagram illustrating the hardware of the task supporting device 2 according to the fourth embodiment. In FIG. 10, the same reference numerals as those in FIG. 2, FIG. 6, and FIG. 8 denote the same or corresponding components, and therefore, detailed explanation of them is not made herein.

The task supporting device 2 illustrated in FIG. 9 includes a positional data acquiring unit 11, the sound data acquiring unit 15, the onomatopoeia registering unit 16, and the text information acquiring unit 21.

The text information acquiring unit 21 includes a task sound acquiring unit 21a and a text information outputting unit 13b.

The text information acquiring unit 21 acquires either positional data or a task identifier from the positional data acquiring unit 11, and acquires sound data from the sound data acquiring unit 15.

The text information acquiring unit 21 acquires, from the onomatopoeia registering unit 16, the onomatopoeia corresponding to the task sound indicated by the sound data as the onomatopoeia corresponding to the task sound of the task to be performed at the task position indicated by the positional data or the task indicated by the task identifier.

The text information acquiring unit 21 identifies the onomatopoeia corresponding to the sound data acquired by the sound data acquiring unit 15 as the onomatopoeia corresponding to the task sound of the task to be performed at the task position indicated by the positional data or the task indicated by the task identifier, when the onomatopoeia corresponding to the task sound indicated by the sound data is not registered in the onomatopoeia registering unit 16.

The task sound acquiring unit 21a is formed with a task sound acquiring circuit 42 shown in FIG. 10, for example.

The task sound acquiring unit 21a acquires either positional data or a task identifier from the positional data acquiring unit 11, and acquires sound data from the sound data acquiring unit 15.

The task sound acquiring unit 21a acquires, from the onomatopoeia registering unit 16, the onomatopoeia corresponding to the task sound indicated by the sound data as the onomatopoeia corresponding to the task sound of the task to be performed at the task position indicated by the positional data or the task indicated by the task identifier.

The task sound acquiring unit 21a identifies the onomatopoeia corresponding to the sound data acquired by the sound data acquiring unit 15 as the task sound of the task to be performed at the task position indicated by the positional data or the task indicated by the task identifier, when the onomatopoeia corresponding to the task sound indicated by the sound data is not registered in the onomatopoeia registering unit 16.

The task sound acquiring unit 21a outputs sound data indicating the onomatopoeia acquired from the onomatopoeia registering unit 16 or sound data indicating the identified onomatopoeia to the text information outputting unit 13b.

In FIG. 9, it is assumed that each of the positional data acquiring unit 11, the sound data acquiring unit 15, the onomatopoeia registering unit 16, the task sound acquiring unit 21a, and the text information outputting unit 13b, which are components of the task supporting device 2, is formed with dedicated hardware as illustrated in FIG. 10. That is, it is assumed that the task supporting device 2 is formed with a positional data acquiring circuit 31, a sound data acquiring circuit 35, an onomatopoeia registering circuit 36, the task sound acquiring circuit 42, and a text information outputting circuit 34.

Each of the positional data acquiring circuit 31, the sound data acquiring circuit 35, the task sound acquiring circuit 42, and the text information outputting circuit 34 is a single circuit, a composite circuit, a programmed processor, a parallel-programmed processor, an ASIC, an FPGA, or a combination thereof, for example.

The components of the task supporting device 2 are not necessarily formed with dedicated hardware, but the task supporting device 2 may be formed with software, firmware, or a combination of software and firmware.

In a case where the task supporting device 2 is formed with software, firmware, or the like, the onomatopoeia registering unit 16 is formed in the memory 51 shown in FIG. 3. A program for causing a computer to execute the respective processing procedures performed in the positional data acquiring unit 11, the sound data acquiring unit 15, the task sound acquiring unit 21a, and the text information outputting unit 13b is stored in the memory 51. The processor 52 shown in FIG. 3 then executes the program stored in the memory 51.

Further, FIG. 10 illustrates an example in which each of the components of the task supporting device 2 is formed with dedicated hardware, and FIG. 3 illustrates an example in which the task supporting device 2 is formed with software, firmware, or the like. Note that this is merely an example, and some components in the task supporting device 2 may be formed with dedicated hardware while the remaining components are formed with software, firmware, or the like.

Next, an operation to be performed by the task supporting system illustrated in FIG. 9 is described. Note that it is the same as the task supporting system illustrated in FIG. 5, except for the task sound acquiring unit 21a. Therefore, only an operation to be performed by the task sound acquiring unit 21a is described herein.

The task sound acquiring unit 21a acquires either positional data or a task identifier from the positional data acquiring unit 11, and acquires sound data from the sound data acquiring unit 15.

Like the task sound acquiring unit 17a shown in FIG. 5, the task sound acquiring unit 21a acquires, from the onomatopoeia registering unit 16, the onomatopoeia that corresponds to the task sound of the task to be performed at the task position indicated by the positional data or the task indicated by the task identifier, and corresponds to the task sound indicated by the sound data, as the onomatopoeia corresponding to the task sound of the task.

When the onomatopoeia corresponding to the task sound indicated by the sound data is not registered in the onomatopoeia registering unit 16, the task sound acquiring unit 21a identifies the onomatopoeia corresponding to the sound data as the onomatopoeia corresponding to the task sound of the task, unlike the task sound acquiring unit 17a shown in FIG. 5.

Specifically, when various task sounds not registered in the onomatopoeia registering unit 16 and the onomatopoeias corresponding to various task sounds are stored in an internal memory of the task sound acquiring unit 21a, for example, the task sound acquiring unit 21a identifies the task sound corresponding to the task sound indicated by the sound data by comparing the task sound indicated by the sound data with the various task sounds stored in the internal memory. The task sound acquiring unit 21a then acquires the onomatopoeia corresponding to the identified task sound from the internal memory.

Examples of the various task sounds not registered in the onomatopoeia registering unit 16 include a task sound to be generated when a task of shaking a box containing a screw is performed. The onomatopoeia corresponding to the task sound is “clink, clink” or “rattle, rattle”, for example.

The task sound acquiring unit 21a outputs sound data indicating the onomatopoeia acquired from the onomatopoeia registering unit 16 or sound data indicating the identified onomatopoeia to the text information outputting unit 13b.

In the fourth embodiment described so far, the task supporting device 2 illustrated in FIG. 9 is designed so that the text information acquiring unit 21 identifies the onomatopoeia corresponding to sound data acquired by the sound data acquiring unit 15 as the onomatopoeia corresponding to the task sound of the task when the onomatopoeia corresponding to the task sound indicated by the sound data acquired by the sound data acquiring unit 15 is not registered in the onomatopoeia registering unit 16. Accordingly, with the task supporting device 2 illustrated in FIG. 9, the worker or the supervisor monitoring the task can check whether the task performed by the worker or the task performed by the supervision target has been correctly performed as with the task supporting device 2 illustrated in FIG. 1, and can also check the task sound even if the worker has performed a task related to a task sound not registered in the onomatopoeia registering unit 16.

### Fifth Embodiment

A fifth embodiment concerns a task supporting device 2 including a progress status determining unit 24 that determines a progress status of a task.

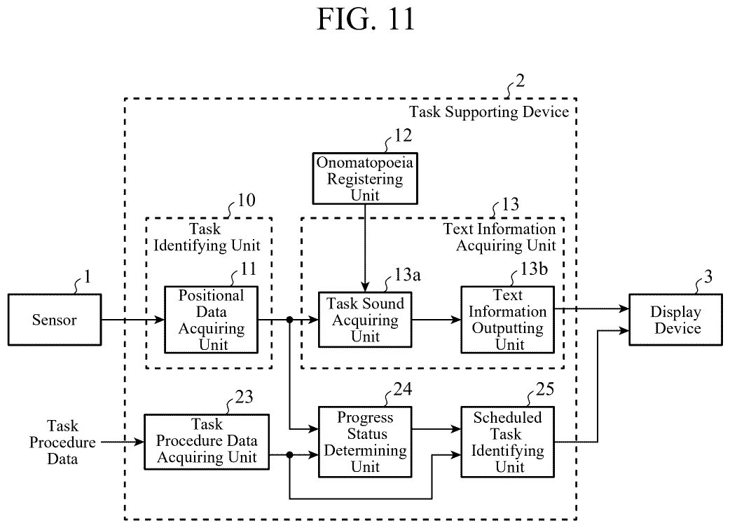

FIG. 11 is a configuration diagram illustrating a task supporting system including the task supporting device 2 according to the fifth embodiment. In FIG. 11, the same reference numerals as those in FIG. 1, FIG. 5, FIG. 7, and FIG. 9 denote the same or corresponding components, and therefore, detailed explanation of them is not made herein.

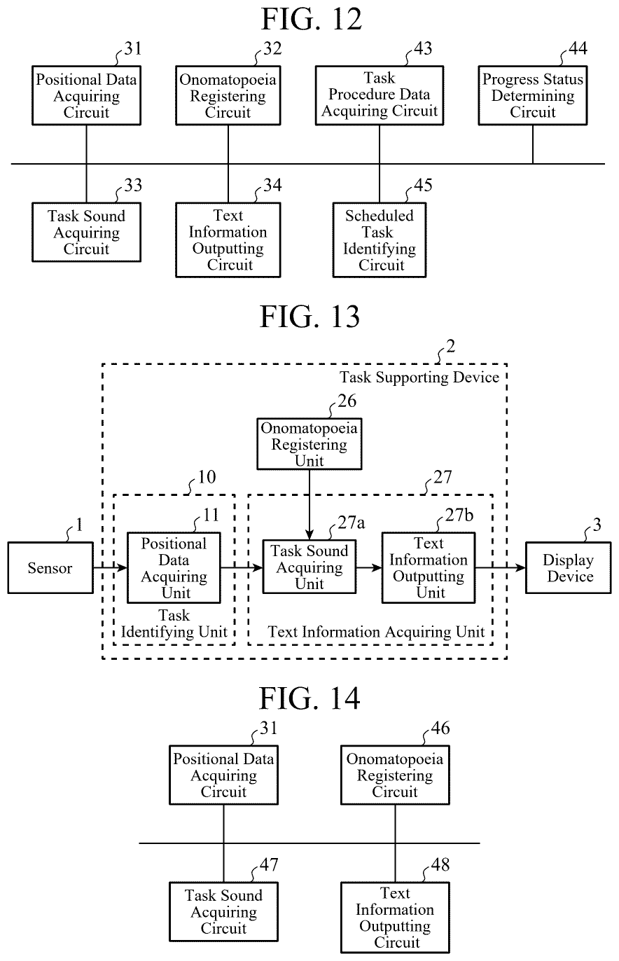

FIG. 12 is a hardware configuration diagram illustrating the hardware of the task supporting device 2 according to the fifth embodiment. In FIG. 12, the same reference numerals as those in FIG. 2, FIG. 6, FIG. 8, and FIG. 10 denote the same or corresponding components, and therefore, detailed explanation of them is not made herein.

The task supporting device 2 illustrated in FIG. 11 includes a positional data acquiring unit 11, an onomatopoeia registering unit 12, a text information acquiring unit 13, a task procedure data acquiring unit 23, the progress status determining unit 24, and a scheduled task identifying unit 25.

The task procedure data acquiring unit 23 is formed with a task procedure data acquiring circuit 43 shown in FIG. 12, for example.

The task procedure data acquiring unit 23 acquires task procedure data indicating the order of the task to be performed by a worker.

The task procedure data acquiring unit 23 outputs the task procedure data to each of the progress status determining unit 24 and the scheduled task identifying unit 25.

The progress status determining unit 24 is formed with a progress status determining circuit 44 shown in FIG. 12, for example.

The progress status determining unit 24 acquires information about the task identified by the task identifying unit 10, and acquires the task procedure data from the task procedure data acquiring unit 23.

The progress status determining unit 24 determines a progress status of the task, on the basis of the information about the task and the task procedure data.

The progress status determining unit 24 outputs a result of the progress status determination to the scheduled task identifying unit 25.

The scheduled task identifying unit 25 is formed with a scheduled task identifying circuit 45 shown in FIG. 12, for example.

The scheduled task identifying unit 25 acquires the task procedure data from the task procedure data acquiring unit 23, and acquires the result of the progress status determination from the progress status determining unit 24.

The scheduled task identifying unit 25 identifies the task scheduled to be performed next by the worker on the basis of the task procedure data and the result of the progress status determination, and causes the display device 3 to display the contents of the identified task.

In the task supporting device 2 illustrated in FIG. 11, each of the task procedure data acquiring unit 23, the progress status determining unit 24, and the scheduled task identifying unit 25 is adopted in the task supporting device 2 illustrated in FIG. 1. Note that this is merely an example, and each of the task procedure data acquiring unit 23, the progress status determining unit 24, and the scheduled task identifying unit 25 may be adopted in the task supporting device 2 illustrated in FIG. 5, the task supporting device 2 illustrated in FIG. 7, or the task supporting device 2 illustrated in FIG. 9.

In FIG. 11, it is assumed that each of the positional data acquiring unit 11, the onomatopoeia registering unit 12, the task sound acquiring unit 13a, the text information outputting unit 13b, the task procedure data acquiring unit 23, the progress status determining unit 24, and the scheduled task identifying unit 25, which are components of the task supporting device 2, is formed with dedicated hardware as illustrated in FIG. 12. That is, it is assumed that the task supporting device 2 is formed with a positional data acquiring circuit 31, an onomatopoeia registering circuit 32, a task sound acquiring circuit 33, a text information outputting circuit 34, the task procedure data acquiring circuit 43, the progress status determining circuit 44, and the scheduled task identifying circuit 45.

Each of the positional data acquiring circuit 31, the task sound acquiring circuit 33, the text information outputting circuit 34, the task procedure data acquiring circuit 43, the progress status determining circuit 44, and the scheduled task identifying circuit 45 is a single circuit, a composite circuit, a programmed processor, a parallel-programmed processor, an ASIC, an FPGA, or a combination thereof, for example.

The components of the task supporting device 2 are not necessarily formed with dedicated hardware, but the task supporting device 2 may be formed with software, firmware, or a combination of software and firmware.

In a case where the task supporting device 2 is formed with software, firmware, or the like, the onomatopoeia registering unit 12 is formed in the memory 51 shown in FIG. 3. A program for causing a computer to execute the respective processing procedures performed in the positional data acquiring unit 11, the task sound acquiring unit 13a, the text information outputting unit 13b, the task procedure data acquiring unit 23, the progress status determining unit 24, and the scheduled task identifying unit 25 is stored in the memory 51. The processor 52 shown in FIG. 3 then executes the program stored in the memory 51.

Further, FIG. 12 illustrates an example in which each of the components of the task supporting device 2 is formed with dedicated hardware, and FIG. 3 illustrates an example in which the task supporting device 2 is formed with software, firmware, or the like. Note that this is merely an example, and some components in the task supporting device 2 may be formed with dedicated hardware while the remaining components are formed with software, firmware, or the like.

Next, an operation to be performed by the task supporting system illustrated in FIG. 11 is described. Note that it is the same as the task supporting system illustrated in FIG. 1, except for the task procedure data acquiring unit 23, the progress status determining unit 24, and the scheduled task identifying unit 25. Therefore, only operations to be performed by the task procedure data acquiring unit 23, the progress status determining unit 24, and the scheduled task identifying unit 25 are described herein.

The task procedure data acquiring unit 23 acquires task procedure data indicating the order of the task to be performed by a worker.

When tasks to be performed by the worker includes a task (1) to tighten a screw to the task object, a task (2) to fit a connector into the task object, and a task (3) to form a hole in the task object, for example, the order of these tasks (1) to (3) is recorded in the task procedure data as shown below.
Task procedure data={task (1)→task (2)→task (3)}

The task procedure data acquiring unit 23 outputs the task procedure data to each of the progress status determining unit 24 and the scheduled task identifying unit 25.

The progress status determining unit 24 acquires positional data from the positional data acquiring unit 11 as the information about the task identified by the task identifying unit 10, and acquires the task procedure data from the task procedure data acquiring unit 23.

The progress status determining unit 24 determines a progress status of the task, on the basis of the positional data and the task procedure data.

The progress status determining unit 24 outputs a result of the progress status determination to the scheduled task identifying unit 25.

In the following, the progress status determining process to be performed by the progress status determining unit 24 is specifically described.

In an internal memory or the like of the progress status determining unit 24, for example, a correspondence relationship between the task positions indicated by positional data and the tasks is recorded as shown below.
Task position (1)→Task (1) to tighten a screw to the task object
Task position (2)→Task (2) to fit a connector into the task object
Task position (3)→Task (3) to form a hole in the task object

The progress status determining unit 24 refers to the correspondence relationship, to identify the task corresponding to the task position indicated by the positional data.

After identifying the task corresponding to the task position, the progress status determining unit 24 determines a progress status of the task, on the basis of the task procedure data.

Specifically, when the task corresponding to the task position is the task position (1), for example, the progress status determining unit 24 determines that the task about to be performed by the worker is the task (1) as a progress status of the task.

When the task corresponding to the task position is the task position (2), for example, the progress status determining unit 24 determines that the task about to be performed by the worker is the task (2) as a progress status of the task.

When the task corresponding to the task position is the task position (3), for example, the progress status determining unit 24 determines that the task about to be performed by the worker is the task (3) as a progress status of the task.

The scheduled task identifying unit 25 acquires the task procedure data from the task procedure data acquiring unit 23, and acquires the result of the progress status determination from the progress status determining unit 24.

The scheduled task identifying unit 25 identifies the task scheduled to be performed next by the worker, on the basis of the task procedure data and the result of the progress status determination.

Specifically, when the task about to be performed by the worker is determined to be the task (1) as a progress status of the task, the scheduled task identifying unit 25 identifies the task (2) as the task scheduled to be performed next by the worker, on the basis of the task procedure data.

When the task about to be performed by the worker is determined to be the task (2) as a progress status of the task, the scheduled task identifying unit 25 identifies the task (3) as the task scheduled to be performed next by the worker, on the basis of the task procedure data.

The scheduled task identifying unit 25 causes the display device 3 to display the contents of the task scheduled to be performed next by the worker.

Specifically, when the task scheduled to be performed next by the worker is the task (2), for example, the scheduled task identifying unit 25 causes the display device 3 to display the contents of the task to “fit a connector into the task object”.

When the task scheduled to be performed next by the worker is the task (3), for example, the scheduled task identifying unit 25 causes the display device 3 to display the contents of the task to “form a hole in the task object”.

The contents of these tasks are stored in an internal memory of the scheduled task identifying unit 25, for example.

In the fifth embodiment described so far, the task supporting device 2 illustrated in FIG. 11 includes: the task procedure data acquiring unit 23 that acquires task procedure data indicating the task procedures of task contents; and the progress status determining unit 24 that determines a progress status of the task, on the basis of information about the task identified by the task identifying unit 10 and the task procedure data acquired by the task procedure data acquiring unit 23. Accordingly, with the task supporting device 2 illustrated in FIG. 11, the worker or the supervisor monitoring the task can check whether the task performed by the worker or the task performed by the supervision target has been correctly performed as with the task supporting device 2 illustrated in FIG. 1, and furthermore, the worker or the supervisor can check the progress status of the task.

Also, in the fifth embodiment, the task supporting device 2 illustrated in FIG. 11 includes the scheduled task identifying unit 25 that identifies the task scheduled to be performed next by the worker on the basis of the task procedure data acquired by the task procedure data acquiring unit 23 and the result of the progress status determination performed by the progress status determining unit 24, and causes the display device 3 to display the contents of the identified task. Thus, with the task supporting device 2 illustrated in FIG. 11, the worker or the supervisor can check the next scheduled task.

### Sixth Embodiment

A sixth embodiment concerns a task supporting device including a text information acquiring unit 27 that acquires any of text information about a sound effect corresponding to a task, text information about a mimetic word corresponding to the task or a sound indicating the mimetic word, or a symbol corresponding to the task on the basis of positional data acquired by a positional data acquiring unit 11, when the task that does not generate any sound is performed by a worker. Each of the sound effect and the sound indicating the mimetic word is a sound to be added as part of rendition, and is not a task sound. Note that, when a task that does not generate any sound is performed by a worker, a sound that is associated with execution of the task is used as a sound effect, for example. In view of this, a sound effect is a concept included in a sound indicating a task.

A mimetic word is a word expressing a state of an object with text, regardless of the actual sound, and includes a word expressing an atmosphere that does not involve any sound, or a word expressing a state that does not involve any sound. Further, a sound indicating a mimetic word is a representation of the mimetic word with a sound, and includes a sound representing an atmosphere that does not involve any sound, or a sound representing a state that does not involve any sound. Both a mimetic word and an imitative sound word are concepts included in an onomatopoetic word. In view of this, a sound indicating a mimetic word corresponding to a task is a concept included in a sound indicating a task.

FIG. 13 is a configuration diagram illustrating a task supporting system including a task supporting device 2 according to the sixth embodiment. In FIG. 13, the same reference numerals as those in FIG. 1, FIG. 5, FIG. 7, FIG. 9, and FIG. 11 denote the same or corresponding components, and therefore, detailed explanation of them is not made herein.

FIG. 14 is a hardware configuration diagram illustrating the hardware of the task supporting device 2 according to the sixth embodiment. In FIG. 14, the same reference numerals as those in FIG. 2, FIG. 6, FIG. 8, FIG. 10, and FIG. 12 denote the same or corresponding components, and therefore, detailed explanation of them is not made herein.

The task supporting device 2 illustrated in FIG. 13 includes a positional data acquiring unit 11, an onomatopoeia registering unit 26, and the text information acquiring unit 27.

The onomatopoeia registering unit 26 is formed with an onomatopoeia registering circuit 46 shown in FIG. 14, for example.

The onomatopoeia registering unit 26 is a database in which onomatopoeias corresponding to task sounds to be generated when tasks are performed at the respective task positions of a plurality of task positions for the task object are registered.

When the task to be performed at each of the task positions is a task that does not generate any sound or a task during which it is difficult for a person to perceive the sound generated in the course of the task sound effects, mimetic words or sounds indicating the mimetic words, or symbols, instead of the onomatopoeias corresponding to task sounds, may be registered in the onomatopoeia registering unit 26.

The task supporting device 2 illustrated in FIG. 13 includes the onomatopoeia registering unit 26 therein. Note that this is merely an example, and the onomatopoeia registering unit 26 may be provided outside the task supporting device 2.

The text information acquiring unit 27 includes a task sound acquiring unit 27a and a text information outputting unit 27b.

The text information acquiring unit 27 acquires positional data from the positional data acquiring unit 11.

Like the text information acquiring unit 13 shown in FIG. 1, the text information acquiring unit 27 acquires text information about a task sound that is a sound indicating a task.

On the basis of the positional data acquired by the positional data acquiring unit 11, the text information acquiring unit 27 may acquire, as the text information about a task sound, any piece of text information about the sound effect corresponding to the task, text information about a mimetic word, text information about a sound indicating the mimetic word, or information about the symbol corresponding to the task.

The text information acquiring unit 27 outputs the acquired text information about a task sound to a display device 3.

The task sound acquiring unit 27a is formed with a task sound acquiring circuit 47 shown in FIG. 14, for example.

The task sound acquiring unit 27a acquires the positional data from the positional data acquiring unit 11.

Like the task sound acquiring unit 13a shown in FIG. 1, the task sound acquiring unit 27a acquires the onomatopoeia corresponding to the task sound of the task, on the basis of the positional data.

Specifically, the task sound acquiring unit 27a acquires, from the onomatopoeia registering unit 26, the onomatopoeia corresponding to the task sound of the task to be performed at the task position indicated by the positional data, as the onomatopoeia corresponding to the task sound of the task.

The task sound acquiring unit 27a outputs sound data indicating the onomatopoeia to the text information outputting unit 27b.

When a task that does not generate any sound is performed by a worker, for example, the task sound acquiring unit 27a may acquire a sound effect or the like corresponding to the task that does not generate any sound, on the basis of the positional data acquired by the positional data acquiring unit 11, unlike the task sound acquiring unit 13a shown in FIG. 1.

Specifically, the task sound acquiring unit 27a acquires, from the onomatopoeia registering unit 26, the sound effect corresponding to the task position indicated by the positional data, a sound indicating the mimetic word corresponding to the task position indicated by the positional data, or the symbol corresponding to the task position indicated by the positional data, as the task sound to be generated when a task that does not generate any sound is performed.

The task sound acquiring unit 27a outputs sound data indicating the sound effect, sound data indicating the mimetic word, or text information about the symbol to the text information outputting unit 27b.

To perform processing similar to the sound effect, the task sound acquiring unit 27a can provisionally acquire the mimetic word as sound data and output the sound data to the text information outputting unit 27b. However, instead of acquiring a sound indicating the mimetic word, it is also possible to acquire text information about the mimetic word, and output the text information as it is to the text information outputting unit 27b.

The text information outputting unit 27b is formed with a text information outputting circuit 48 shown in FIG. 14, for example.

When sound data indicating an onomatopoeia is output from the task sound acquiring unit 27a, the text information outputting unit 27b converts the onomatopoeia indicated by the sound data into text information.

When sound data indicating a sound effect is output from the task sound acquiring unit 27a, the text information outputting unit 27b converts the sound effect indicated by the sound data into text information.

When sound data indicating a mimetic word is output from the task sound acquiring unit 27a, the text information outputting unit 27b converts the mimetic word indicated by the sound data into text information.

When information about a symbol is output from the task sound acquiring unit 27a, the text information outputting unit 27b converts, as necessary, the symbol indicated by the information about a symbol into data that can be displayed by the display device 3. The text information outputting unit 27b may convert the acquired information about a symbol into either text information or image data, for example. When the acquired information about a symbol is data that can already be displayed by the display device 3, the text information outputting unit 27b may skip the above conversion process.

The text information outputting unit 27b outputs the text information about an onomatopoeia, the text information of a sound effect, the text information of a mimetic word, or the symbol to the display device 3.

In the task supporting device 2 illustrated in FIG. 13, each of the onomatopoeia registering unit 26 and the text information acquiring unit 27 is adopted in the task supporting device 2 illustrated in FIG. 1. Note that this is merely an example, and each of the onomatopoeia registering unit 26 and the text information acquiring unit 27 may be adopted in the task supporting device 2 illustrated in FIG. 5, the task supporting device 2 illustrated in FIG. 7, the task supporting device 2 illustrated in FIG. 9, or the task supporting device 2 illustrated in FIG. 11.

In FIG. 13, it is assumed that each of the positional data acquiring unit 11, the onomatopoeia registering unit 26, the task sound acquiring unit 27a, and the text information outputting unit 27b, which are components of the task supporting device 2, is formed with dedicated hardware as illustrated in FIG. 14. That is, it is assumed that the task supporting device 2 is formed with a positional data acquiring circuit 31, the onomatopoeia registering circuit 46, the task sound acquiring circuit 47, and the text information outputting circuit 48.

Here, the onomatopoeia registering circuit 46 may be a nonvolatile or volatile semiconductor memory such as a RAM, a ROM, a flash memory, an EPROM, or an EEPROM, a magnetic disk, a flexible disk, an optical disk, a compact disk, a mini disk, or a DVD, for example.

Meanwhile, each of the positional data acquiring circuit 31, the task sound acquiring circuit 47, and the text information outputting circuit 48 is a single circuit, a composite circuit, a programmed processor, a parallel-programmed processor, an ASIC, an FPGA, or a combination thereof, for example.

The components of the task supporting device 2 are not necessarily formed with dedicated hardware, but the task supporting device 2 may be formed with software, firmware, or a combination of software and firmware.

In a case where the task supporting device 2 is formed with software, firmware, or the like, the onomatopoeia registering unit 26 is formed in the memory 51 shown in FIG. 3. A program for causing a computer to execute the respective processing procedures performed in the positional data acquiring unit 11, the task sound acquiring unit 27a, and the text information outputting unit 27b is stored in the memory 51. The processor 52 shown in FIG. 3 then executes the program stored in the memory 51.

Further, FIG. 14 illustrates an example in which each of the components of the task supporting device 2 is formed with dedicated hardware, and FIG. 3 illustrates an example in which the task supporting device 2 is formed with software, firmware, or the like. Note that this is merely an example, and some components in the task supporting device 2 may be formed with dedicated hardware while the remaining components are formed with software, firmware, or the like.

Next, an operation to be performed by the task supporting system illustrated in FIG. 13 is described. Note that it is the same as the task supporting system illustrated in FIG. 1, except for the onomatopoeia registering unit 26, the task sound acquiring unit 27a, and the text information outputting unit 27b. Therefore, only operations to be performed by the onomatopoeia registering unit 26, the task sound acquiring unit 27a, and the text information outputting unit 27b are described herein.

In the onomatopoeia registering unit 26, onomatopoeias corresponding to task sounds to be generated when tasks are performed at the respective task positions for a task object are registered.

There are eight task positions (1) to (8) as the task positions for the task object, for example.

When the tasks at three task positions (1) to (3) are tasks that generate sounds, the task position (1) is a position at which a screw is tightened into the task object with an electric screwdriver, for example, the task position (2) is a position at which a connector is fitted, for example, and the task position (3) is a position at which a hole is formed in the task object with an electric drill, for example.

In such a case, the onomatopoeias as shown below are registered in the onomatopoeia registering unit 26 as the onomatopoeias corresponding to the task sounds to be generated when tasks are performed at the respective task positions (1) to (3), for example.
Task position (1)→Onomatopoeia “boooom”
Task position (2)→Onomatopoeia “click”
Task position (3)→Onomatopoeia “squeak, squeak”

When the tasks to be performed at the task positions (4) to (8) are tasks that do not generate any sound, the task position (4) is a position at which moisture is wiped off the task object with a cloth, for example.

In such a case, the sound effect as shown below is registered in the onomatopoeia registering unit 26 as the sound effect corresponding to the task sound to be generated when the task is performed at the task position (4), for example.
Task position (4)→Sound effect “swoosh”

In the case of a task to align the position of a part with the task object, for example, the task position (5) is a position at which the part is aligned with the task object, and the task position (6) is a position at which a dial of the task object is turned.

In such a case, sounds indicating the mimetic words as shown below are registered in the onomatopoeia registering unit 26 as the sounds indicating the mimetic words corresponding to the task sounds to be generated when the tasks are performed at the respective task positions (5) and (6), for example.
Task position (5)→Sound indicating a mimetic word “click”
Task position (6)→Sound indicating a mimetic word “tick, tick, tick”

The task position (7) is the position corresponding to a feature point of a part requiring attention to the attachment direction, for example, and the task position (8) is a position of a protrusion of a part to be attached to the task object, for example.

In such a case, the symbols as shown below are registered in the onomatopoeia registering unit 26 as the symbols corresponding to the task sounds to be generated when the tasks are performed at the respective task positions (7) and (8), for example.
Task position (7)→symbol “″”
Task position (8)→symbol “!”

The task sound acquiring unit 27a acquires positional data from the positional data acquiring unit 11.

The task sound acquiring unit 27a acquires, from the onomatopoeia registering unit 26, the onomatopoeia corresponding to the task position indicated by the positional data, the sound effect corresponding to the task position indicated by the positional data, the sound indicating the mimetic word corresponding to the task position indicated by the positional data, or the symbol corresponding to the task position indicated by the positional data, as the task sound to be generated when a task is performed by a worker.

When the task position indicated by the positional data is the task position (1), for example, the task sound acquiring unit 27a acquires “boooom” as the onomatopoeia.

When the task position indicated by the positional data is the task position (2), for example, the task sound acquiring unit 27a acquires “click” as the onomatopoeia.

When the task position indicated by the positional data is the task position (3), for example, the task sound acquiring unit 27a acquires “squeak, squeak” as the onomatopoeia.

When the task position indicated by the positional data is the task position (4), for example, the task sound acquiring unit 27a acquires “swoosh” as the sound effect.

When the task position indicated by the positional data is the task position (5), for example, the task sound acquiring unit 27a acquires “click” as the sound indicating the mimetic word.

When the task position indicated by the positional data is the task position (6), for example, the task sound acquiring unit 27a acquires “tick, tick, tick” as the sound indicating the mimetic word.

When the task position indicated by the positional data is the task position (7), for example, the task sound acquiring unit 27a acquires “″” as the symbol.

When the task position indicated by the positional data is the task position (8), for example, the task sound acquiring unit 27a acquires “!” as the symbol.

The task sound acquiring unit 27a outputs sound data indicating the acquired onomatopoeia, sound data indicating the acquired sound effect, sound data indicating the acquired mimetic word, or the acquired symbol to the text information outputting unit 27b.

The text information outputting unit 27b acquires, from the task sound acquiring unit 27a, the sound data indicating the onomatopoeia, the sound data indicating the sound effect, the sound data indicating the mimetic word, or the symbol.

When acquiring the sound data indicating the onomatopoeia, the text information outputting unit 27b converts the onomatopoeia indicated by the sound data into text information.

When acquiring the sound data indicating the sound effect, the text information outputting unit 27b converts the sound effect indicated by the sound data into text information.

When acquiring the sound data indicating the mimetic word, the text information outputting unit 27b converts the mimetic word indicated by the sound data into text information.

The text information outputting unit 27b outputs either converted text information or the acquired symbol to the display device 3.

As a result, text information or the symbol is displayed on the display device 3.

When the task position indicated by the positional data is the task position (1), for example, the text information indicating “boooom” is displayed on the display device 3, and, when it is the task position (4), the text information indicating “swoosh” is displayed on the display device 3.

When the task position indicated by the positional data is the task position (5), for example, the text information indicating “click” is displayed on the display device 3, and, when it is the task position (7), the symbol “″” is displayed on the display device 3.

The text information or the symbol on the display device 3 may be displayed as AR display, using an onomatopoetic expression as in a cartoon or a balloon as in a cartoon, for example.

In the sixth embodiment described so far, the task supporting device 2 is designed so that the text information acquiring unit 27 acquires, as the text information of the task sound of an identified task, text information about the sound effect corresponding to the task, text information about the sound indicating the mimetic word corresponding to the task, or the symbol corresponding to the task. Accordingly, with the task supporting device 2, the worker or the supervisor monitoring the task can check whether the task performed by the worker or the task performed by the supervision target has been correctly performed, regardless of whether the task performed by the worker is a task that generates sound, or is a task that does not generate any sound.

### Seventh Embodiment

A seventh embodiment concerns a task supporting device 2 including a correctness/incorrectness determining unit 28 that determines correctness/incorrectness of a task.

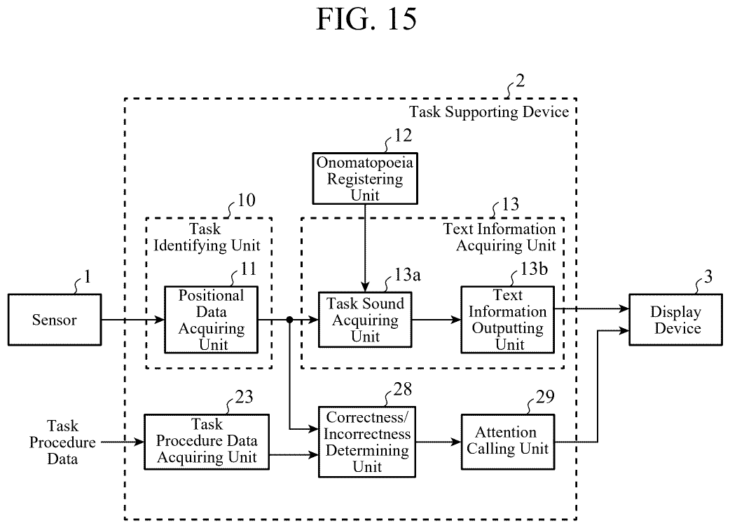

FIG. 15 is a configuration diagram illustrating a task supporting system including the task supporting device 2 according to the seventh embodiment. In FIG. 15, the same reference numerals as those in FIG. 1, FIG. 5, FIG. 7, FIG. 9, FIG. 11, and FIG. 13 denote the same or corresponding components, and therefore, detailed explanation of them is not made herein.

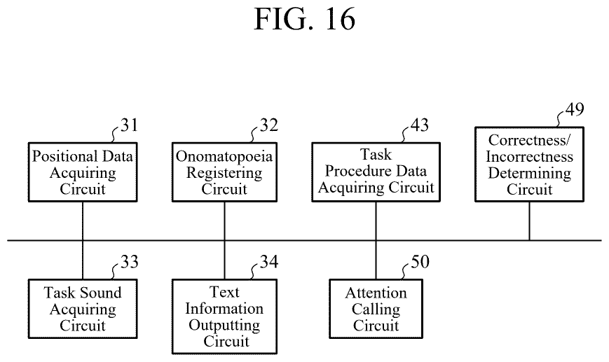

FIG. 16 is a hardware configuration diagram illustrating the hardware of the task supporting device 2 according to the seventh embodiment. In FIG. 16, the same reference numerals as those in FIG. 2, FIG. 6, FIG. 8, FIG. 10, FIG. 12, and FIG. 14 denote the same or corresponding components, and therefore, detailed explanation of them is not made herein.

The task supporting device 2 illustrated in FIG. 15 includes a positional data acquiring unit 11, an onomatopoeia registering unit 12, a text information acquiring unit 13, a task procedure data acquiring unit 23, the correctness/incorrectness determining unit 28, and an attention calling unit 29.

The correctness/incorrectness determining unit 28 is formed with a correctness/incorrectness determining circuit 49 shown in FIG. 16, for example.

The correctness/incorrectness determining unit 28 acquires positional data from the positional data acquiring unit 11, and acquires task procedure data from the task procedure data acquiring unit 23.

The correctness/incorrectness determining unit 28 determines correctness/incorrectness of the task on the basis of the positional data and the task procedure data.

The correctness/incorrectness determining unit 28 outputs the result of the correctness/incorrectness determination to the attention calling unit 29.

The attention calling unit 29 is formed with an attention calling circuit 50 shown in FIG. 16, for example.

The attention calling unit 29 acquires the result of the correctness/incorrectness determination from the correctness/incorrectness determining unit 28.

When the result of the determination by the correctness/incorrectness determining unit 28 indicates incorrectness of the task, the attention calling unit 29 calls the worker's attention.

In the task supporting device 2 illustrated in FIG. 15, each of the task procedure data acquiring unit 23, the correctness/incorrectness determining unit 28, and the attention calling unit 29 is adopted in the task supporting device 2 illustrated in FIG. 1. Note that this is merely an example, and each of the task procedure data acquiring unit 23, the correctness/incorrectness determining unit 28, and the attention calling unit 29 may be adopted in the task supporting device 2 illustrated in FIG. 5, the task supporting device 2 illustrated in FIG. 7, the task supporting device 2 illustrated in FIG. 9, the task supporting device 2 illustrated in FIG. 11, or the task supporting device 2 illustrated in FIG. 13.

In FIG. 15, it is assumed that each of the positional data acquiring unit 11, the onomatopoeia registering unit 12, a task sound acquiring unit 13a, a text information outputting unit 13b, the task procedure data acquiring unit 23, the correctness/incorrectness determining unit 28, and the attention calling unit 29, which are components of the task supporting device 2, is formed with dedicated hardware as illustrated in FIG. 16. That is, it is assumed that the task supporting device 2 is formed with a positional data acquiring circuit 31, an onomatopoeia registering circuit 32, a task sound acquiring circuit 33, a text information outputting circuit 34, the task procedure data acquiring circuit 43, the correctness/incorrectness determining circuit 49, and the attention calling circuit 50.

Each of the positional data acquiring circuit 31, the task sound acquiring circuit 33, the text information outputting circuit 34, the task procedure data acquiring circuit 43, the correctness/incorrectness determining circuit 49, and the attention calling circuit 50 is a single circuit, a composite circuit, a programmed processor, a parallel-programmed processor, an ASIC, an FPGA, or a combination thereof, for example.

The components of the task supporting device 2 are not necessarily formed with dedicated hardware, but the task supporting device 2 may be formed with software, firmware, or a combination of software and firmware.

In a case where the task supporting device 2 is formed with software, firmware, or the like, the onomatopoeia registering unit 12 is formed in the memory 51 of the computer illustrated in FIG. 3. A program for causing a computer to execute the respective processing procedures performed in the positional data acquiring unit 11, the task sound acquiring unit 13a, the text information outputting unit 13b, the task procedure data acquiring unit 23, the correctness/incorrectness determining unit 28, and the attention calling unit 29 is stored in the memory 51. The processor 52 shown in FIG. 3 then executes the program stored in the memory 51.

Further, FIG. 16 illustrates an example in which each of the components of the task supporting device 2 is formed with dedicated hardware, and FIG. 3 illustrates an example in which the task supporting device 2 is formed with software, firmware, or the like. Note that this is merely an example, and some components in the task supporting device 2 may be formed with dedicated hardware while the remaining components are formed with software, firmware, or the like.

Next, an operation to be performed by the task supporting system illustrated in FIG. 15 is described. Note that it is the same as the task supporting system illustrated in FIG. 11, except for the correctness/incorrectness determining unit 28 and the attention calling unit 29. Therefore, only the operations to be performed by the correctness/incorrectness determining unit 28 and the attention calling unit 29 are described herein.

The correctness/incorrectness determining unit 28 acquires positional data from the positional data acquiring unit 11, and acquires task procedure data from the task procedure data acquiring unit 23.

The correctness/incorrectness determining unit 28 determines correctness/incorrectness of the task to be performed by the worker, on the basis of the positional data and the task procedure data.

In the following, the correctness/incorrectness determining process to be performed by the correctness/incorrectness determining unit 28 is specifically described.

In an internal memory or the like of the correctness/incorrectness determining unit 28, for example, a correspondence relationship between the task positions indicated by positional data and tasks is recorded as shown below.
Task position (1)→Task (1) to tighten a screw to the task object
Task position (2)→Task (2) to fit a connector into the task object
Task position (3)→Task (3) to form a first hole in the task object
Task position (4)→Task (4) to form a second hole in the task object

In the internal memory or the like of the correctness/incorrectness determining unit 28, a history of past tasks performed by the worker is recorded.

When the task (1) to tighten a screw into the task object and the task (2) to fit a connector to the task object have already been performed by the worker, and the task (1) and the task (2) have been correctly performed, for example, a task history indicating that the task (1) and the task (2) have been performed is recorded.

The correctness/incorrectness determining unit 28 identifies the task about to be performed by the worker, on the basis of the positional data acquired from the positional data acquiring unit 11.

When the task position indicated by the positional data is the task position (3), for example, the correctness/incorrectness determining unit 28 identifies the task (3) to form the first hole in the task object as the task about to be performed by the worker.

When the task position indicated by the positional data is the task position (4), for example, the correctness/incorrectness determining unit 28 identifies the task (4) to form the second hole in the task object as the task about to be performed by the worker.

Also, the correctness/incorrectness determining unit 28 compares the order of the tasks indicated by the task procedure data with the task history recorded in the internal memory or the like, to identify the correct task to be performed by the worker.

When the task history recorded in the internal memory or the like indicates that the task (1) and the task (2) have been performed, for example, the correctness/incorrectness determining unit 28 identifies the task (3) as the correct task to be performed by the worker.

The correctness/incorrectness determining unit 28 may determine whether to proceed to the next task on the basis of the text information about a task sound the text information acquiring unit 13 has output to the display device 3.

Specifically, when text information about the task sounds and the like displayed so far is stored as a task history, for example, the correctness/incorrectness determining unit 28 can also determine whether the worker may proceed to the next task, by determining whether text information about a predetermined task sound or the like is correctly displayed. When the sound to be generated when a screw is tightened completely is acquired and displayed as a task sound according to the specification, for example, it is possible to easily determine whether a screw tightening process has been correctly performed, by determining whether the task sound is displayed. In this manner, it is also possible to use the presence or absence of display of text information about a task sound or the like in determining completion of each task.

When the task about to be performed by the worker matches the correct task to be performed by the worker, the correctness/incorrectness determining unit 28 determines that the task about to be performed by the worker is the correct task.

When the task about to be performed by the worker does not match the correct task to be performed by the worker, the correctness/incorrectness determining unit 28 determines that the task about to be performed by the worker is not the correct task.

The correctness/incorrectness determining unit 28 outputs the result of the correctness/incorrectness determination to the attention calling unit 29.

The attention calling unit 29 acquires the result of the correctness/incorrectness determination from the correctness/incorrectness determining unit 28.

When the result of the determination by the correctness/incorrectness determining unit 28 indicates that the task about to be performed by the worker is an incorrect task, the attention calling unit 29 calls the worker's attention by causing the display device 3 to display a “message indicating that an incorrect task is about to be performed”, for example.

In the seventh embodiment described so far, the task supporting device 2 illustrated in FIG. 15 includes: the task procedure data acquiring unit 23 that acquires task procedure data indicating the task procedures of task contents; the correctness/incorrectness determining unit 28 that determines correctness/incorrectness of the task on the basis of positional data acquired by the positional data acquiring unit 11 and the task procedure data acquired by the task procedure data acquiring unit 23; and the attention calling unit 29 that calls the worker's attention when the result of the determination by the correctness/incorrectness determining unit 28 indicates incorrectness of the task. Accordingly, with the task supporting device 2 illustrated in FIG. 15, it is possible to prevent an incorrect task from being performed by the worker.

In the first to seventh embodiments, the task supporting device 2 outputs text information about a task sound to the display device 3 when a worker performs a task with his/her own hand. Note that this is merely an example, and the task supporting device 2 may output text information about a task sound to the display device 3 when a worker remotely operates an arm of a robot to cause the arm to perform a task. In this case, the display device 3 is disposed at a position visible to the worker.

Thus, even when the worker is in a remote place away from the task site, the worker can check whether the task has been correctly performed, by viewing the text information displayed on the display device 3.

Note that, in the present disclosure, it is possible to freely combine the embodiments to one another, modify any of the components of each of the embodiments, or omit any of the components in each of the embodiments.

### Industrial Applicability

The present disclosure is suitable for a task supporting device, a task supporting method, and a task supporting system.

### REFERENCE SIGNS LIST

1: sensor, 2: task supporting device, 3: display device, 4: microphone, 10: task identifying unit, 11: positional data acquiring unit, 12: onomatopoeia registering unit, 13: text information acquiring unit, 13a: task sound acquiring unit, 13b: text information outputting unit, 15: sound data acquiring unit, 16: onomatopoeia registering unit, 17: text information acquiring unit, 17a: task sound acquiring unit, 18: sound data extracting unit, 19: environmental sound identifying unit, 20: text information acquiring unit, 20a: task sound acquiring unit, 20b: text information outputting unit, 21: text information acquiring unit, 21a: task sound acquiring unit, 23: task procedure data acquiring unit, 24: progress status determining unit, 25: scheduled task identifying unit, 26: onomatopoeia registering unit, 27: text information acquiring unit, 27a: task sound acquiring unit, 27b: text information outputting unit, 28: correctness/incorrectness determining unit, 29: attention calling unit, 31: positional data acquiring circuit, 32: onomatopoeia registering circuit, 33: task sound acquiring circuit, 34: text information outputting circuit, 35: sound data acquiring circuit, 36: onomatopoeia registering circuit, 37: task sound acquiring circuit, 38: sound data extracting circuit, 39: environmental sound identifying circuit, 40: task sound acquiring circuit, 41: text information outputting circuit, 42: task sound acquiring circuit, 43: task procedure data acquiring circuit, 44: progress status determining circuit, 45: scheduled task identifying circuit, 46: onomatopoeia registering circuit, 47: task sound acquiring circuit, 48: text information outputting circuit, 49: correctness/incorrectness determining circuit, 50: attention calling circuit, 51: memory, 52: processor

1. A task supporting device comprising processing circuitry
to identify a task to be a support target; and
to acquire text information about a task sound that is a sound indicating the task identified.

2. The task supporting device according to claim 1, wherein
the processing circuitry
acquires, from memory in which information about an onomatopoeia corresponding to the task sound is registered, information about the onomatopoeia corresponding to the task sound of the task identified as a task sound of a task that can be the support target, and outputs text information about the onomatopoeia to a display device on a basis of the information about the onomatopoeia acquired.

3. The task supporting device according to claim 2, wherein
sound data of the onomatopoeia is registered as the information about the onomatopoeia in the memory, and
the processing circuitry converts the acquired sound data of the onomatopoeia into text information, and outputs the converted text information to the display device.

4. The task supporting device according to claim 2, wherein
an onomatopoeia corresponding to a task sound to be generated when a task is correctly performed, and an onomatopoeia corresponding to a task sound to be generated when the task is not correctly performed are registered in the memory,
the processing circuitry is further configured to acquire sound data indicating the task sound from a microphone that collects the task sound to be generated when the task as the support target is performed, and
the processing circuitry
acquires, from the memory, an onomatopoeia corresponding to the task sound indicated by the sound data acquired by the processing circuitry as the onomatopoeia corresponding to the task sound of the identified task.

5. The task supporting device according to claim 4, the processing circuitry further being configured
to extract the sound data indicating the task sound from the acquired sound data, when the sound data acquired by the processing circuitry includes sound data indicating a task sound and sound data indicating an environmental sound, wherein
the processing circuitry
acquires, from the memory, an onomatopoeia corresponding to the task sound indicated by the sound data extracted by the processing circuitry as the onomatopoeia corresponding to the task sound of the identified task.

6. The task supporting device according to claim 5, wherein
the processing circuitry extracts the sound data indicating the environmental sound from the acquired sound data, when the sound data acquired by the processing circuitry includes the sound data indicating the task sound and the sound data indicating the environmental sound, and
the processing circuitry is further configured to acquire an onomatopoeia corresponding to the environmental sound indicated by the sound data extracted by the processing circuitry.

7. The task supporting device according to claim 5, wherein,
when the onomatopoeia corresponding to the task sound indicated by the sound data acquired by the processing circuitry is not registered in the memory, the processing circuitry
identifies the onomatopoeia corresponding to the sound data acquired by the processing circuitry as the onomatopoeia corresponding to the task sound of the identified task.

8. The task supporting device according to claim 1, wherein the processing circuitry identifies the task to be the support target, on a basis of task instruction data indicating an instruction about a task to be performed next.

9. The task supporting device according to claim 1, wherein
the processing circuitry is further configured to acquire positional data indicating a task position, from a sensor that detects the task position at which the task as the support target is performed, and
identifies the task to be the support target, on a basis of the positional data acquired by the processing circuitry.

10. The task supporting device according to claim 9, wherein
the sensor
detects the task position, on a basis of task instruction data indicating a task to be performed next, and
the processing circuitry acquires, from the sensor, the positional data indicating the task position detected on a basis of the task instruction data.

11. The task supporting device according to claim 1, wherein the processing circuitry is further configured to acquire task procedure data indicating a task order; and
to determine a progress status of the task, on a basis of information about the task identified by the processing circuitry and the task procedure data acquired by the processing circuitry.

12. The task supporting device according to claim 11, wherein the processing circuitry is further configured to identify a task scheduled to be performed next on a basis of the task procedure data acquired by the processing circuitry and a determination result of the progress status performed by the processing circuitry, and cause a display device to display contents of the identified task.

13. The task supporting device according to claim 1, wherein
the processing circuitry
acquires, as the text information about the task sound of the identified task, at least one piece of information among text information about a sound effect corresponding to the task, text information about a sound indicating a mimetic word corresponding to the task, and a symbol corresponding to the task.

14. The task supporting device according to claim 2, wherein the processing circuitry is further configured to determine correctness or incorrectness of the task on a basis of the text information about the task sound the processing circuitry has output to the display device; and
to call worker's attention when a result of the determination by the processing circuitry indicates the incorrectness of the task.

15. The task supporting device according to claim 14, wherein the processing circuitry determines whether to proceed to a next task on a basis of the text information about the task sound the processing circuitry has output to the display device.

16. A task supporting method comprising:
identifying a task to be a support target; and
acquiring text information about a task sound that is a sound indicating the task identified.

17. A task supporting system comprising processing circuitry
to identify a task to be a support target;
to acquire text information about a task sound that is a sound indicating the task identified by the processing circuitry; and
to display text indicating the task sound, in accordance with the text information output from the processing circuitry.

18. The task supporting system according to claim 17, wherein the processing circuitry is further configured to detect a task position that is a position at which the task as the support target is performed, to acquire positional data indicating the task position from the sensor, and
to identify the task to be the support target, on a basis of the positional data acquired by processing circuitry.

19. The task supporting system according to claim 18, wherein
the sensor
detects the task position, on a basis of task instruction data indicating a task to be performed next, and
the processing circuitry acquires, from the sensor, the positional data indicating the task position detected on a basis of the task instruction data.
